(19) United States
(12) Patent Application Publication
(10) Pub. No.: US 2022/0312470 A1
(43) Pub. Date: Sep. 29, 2022

(54) OPERATION METHOD IN DORMANT BWP BASED ON INITIAL ACCESS, AND TERMINAL USING METHOD

(71) Applicant: LG Electronics Inc., Seoul (KR)

(72) Inventors: Inkwon SEO, Seoul (KR); Joonkui AHN, Seoul (KR); Suckchel YANG, Seoul (KR); Seonwook KIM, Seoul (KR)

(21) Appl. No.: 17/765,939

(22) PCT Filed: Sep. 2, 2020
(86) PCT No.: PCT/KR2020/011772

§ 371 Date: Apr. 1, 2022

Related U.S. Application Data
(60) Provisional application No. 62/910,381, filed on Oct. 3, 2019.

(51) Int. Cl. H04W 72/12; H04L 5/00; H04W 24/08

(52) U.S. Cl. CPC H04W 72/1289; H04L 5/0098; H04W 24/08; H04L 5/0055

(57) ABSTRACT

The present specification provides a method by which a terminal performs initial access in a wireless communication system, comprising: transmitting a random access (RA) preamble to a base station; receiving a random access response (RAR) from the base station; receiving dormant bandwidth part (BWP) configuration information from the base station, the dormant BWP configuration information being information about a downlink BWP used as a dormant BWP, from among one or more downlink BWPs set to the terminal; receiving, from the base station, downlink control information (DCI) notifying the activation of the dormant BWP; and stopping physical downlink control channel (PDCCH) monitoring on the dormant BWP, wherein a BWP inactivity timer, which is a timer for the transition to a default BWP, is not used on the basis of the activation of the dormant BWP.

### BACKGROUND OF THE DISCLOSURE

### Field of the Disclosure

The present disclosure relates to wireless communication.

### Related Art

As a growing number of communication devices require higher communication capacity, there is a need for advanced mobile broadband communication as compared to existing radio access technology (RAT). Massive machine-type communication (MTC), which provides a variety of services anytime and anywhere by connecting a plurality of devices and a plurality of objects, is also one major issue to be considered in next-generation communication. In addition, designs for communication systems considering services or user equipments (UEs) sensitive to reliability and latency are under discussion. Introduction of next-generation RAT considering enhanced mobile broadband communication, massive MTC, and ultra-reliable and low-latency communication (URLLC) is under discussion. In the disclosure, for convenience of description, this technology may be referred to as new RAT or new radio (NR).

In the NR system, each serving cell may be configured with a plurality of (e.g., maximum 4) bandwidth parts (BWP). Accordingly, a dormancy operation for each cell and/or BWP needs to be defined.

### SUMMARY

According to an embodiment of the present disclosure, provided is a method of transmitting a random access (RA) preamble to a base station, receiving a random access response (RAR) from the base station, receiving from the base station dormant bandwidth part (BWP) configuration information, receiving downlink control information (DCI) informing the activation of the dormant BWP from the base station and stopping PDCCH (physical downlink control channel) monitoring on the dormant BWP, where the dormant BWP configuration information is information on a downlink BWP used as a dormant BWP among at least one downlink BWP configured for the terminal, and based on the activation of the dormant BWP, a BWP inactivity timer for transition to the default BWP is not used.

According to the present disclosure, when the terminal is in the dormant BWP, the existing BWP inactivity timer is not used. Accordingly, when the terminal is in the dormant BWP for power saving, the problem that the terminal is forcibly transferred to the default (unintentionally) can be solved.

Effects obtained through specific examples of this specification are not limited to the foregoing effects. For example, there may be a variety of technical effects that a person having ordinary skill in the related art can understand or derive from this specification. Accordingly, specific effects of the disclosure are not limited to those explicitly indicated herein but may include various effects that may be understood or derived from technical features of the disclosure.

### BRIEF DESCRIPTION OF THE DRAWINGS

FIG. 1 shows another example of a wireless communication system to which a technical feature of the present disclosure can be applied.

FIG. 2 illustrates physical channels used in the 3GPP system and a general signal transmission procedure.

FIG. 3 illustrates a synchronization signal and PBCH (SS/PBCH) block.

FIG. 4 illustrates a method for obtaining timing information by a UE.

FIG. 5 illustrates one example of a system information acquisition procedure of a UE.

FIG. 6 illustrates a random access procedure.

FIG. 7 illustrates a power ramping counter.

FIG. 8 illustrates a threshold of an SS block in the RACH resource relationship.

FIG. 9 illustrates an example of a frame structure that may be applied in NR.

FIG. 10 illustrates an example of a frame structure for new radio access technology.

FIG. 11 shows examples of 5G usage scenarios to which the technical features of the present disclosure can be applied.

FIG. 12 illustrates dormant behavior.

FIG. 13 illustrates an example of the BWP operation of the UE.

FIG. 14 illustrates another example of the BWP operation of the UE.

FIG. 15 is a flowchart of an initial access method according to an embodiment of the present disclosure.

FIG. 16 is a flowchart of an initial access method from the viewpoint of a terminal, according to an embodiment of the present specification.

FIG. 17 is a block diagram of an example of an initial access device from the viewpoint of a terminal, according to an embodiment of the present disclosure.

FIG. 18 is a flowchart of an initial access method from a base station perspective, according to an embodiment of the present disclosure.

FIG. 19 is a block diagram of an example of an initial access device from the viewpoint of a base station, according to an embodiment of the present disclosure.

FIG. 20 illustrates a communication system 1 applied to the disclosure.

FIG. 21 illustrates a wireless device that is applicable to the disclosure.

FIG. 22 illustrates another example of a wireless device applicable to the present disclosure.

FIG. 23 illustrates a signal processing circuit for a transmission signal.

FIG. 24 illustrates another example of a wireless device applied to the disclosure.

FIG. 25 illustrates a hand-held device applied to the disclosure.

FIG. 26 illustrates a vehicle or an autonomous driving vehicle applied to the disclosure.

FIG. 27 is a diagram illustrating an example of a communication structure that can be provided in a 6G system.

### DESCRIPTION OF EXEMPLARY EMBODIMENTS

As used herein, “A or B” may mean “only A”, “only B”, or “both A and B”. That is, “A or B” may be interpreted as “A and/or B” herein. For example, “A, B or C” may mean “only A”, “only B”, “only C”, or “any combination of A, B, and C”.

As used herein, a slash (/) or a comma (,) may mean “and/or”. For example, “A/B” may mean “A and/or B”. Therefore, “A/B” may include “only A”, “only B”, or “both A and B”. For example, “A, B, C” may mean “A, B, or C”.

As used herein, “at least one of A and B” may mean “only A”, “only B”, or “both A and B”. Further, as used herein, “at least one of A or B” or “at least one of A and/or B” may be interpreted equally as “at least one of A and B”.

As used herein, “at least one of A, B, and C” may mean “only A”, “only B”, “only C”, or “any combination of A, B, and C”. Further, “at least one of A, B, or C” or “at least one of A, B, and/or C” may mean “at least one of A, B, and C”.

As used herein, parentheses may mean “for example”. For instance, the expression “control information (PDCCH)” may mean that a PDCCH is proposed as an example of control information. That is, control information is not limited to a PDCCH, but a PDCCH is proposed as an example of control information. Further, the expression “control information (i.e., a PDCCH)” may also mean that a PDCCH is proposed as an example of control information.

Technical features that are separately described in one drawing may be implemented separately or may be implemented simultaneously.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

A PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time (e.g., slot, symbol) for subframe transmission.

Technical features that are separately described in one drawing may be implemented separately or may be implemented simultaneously.

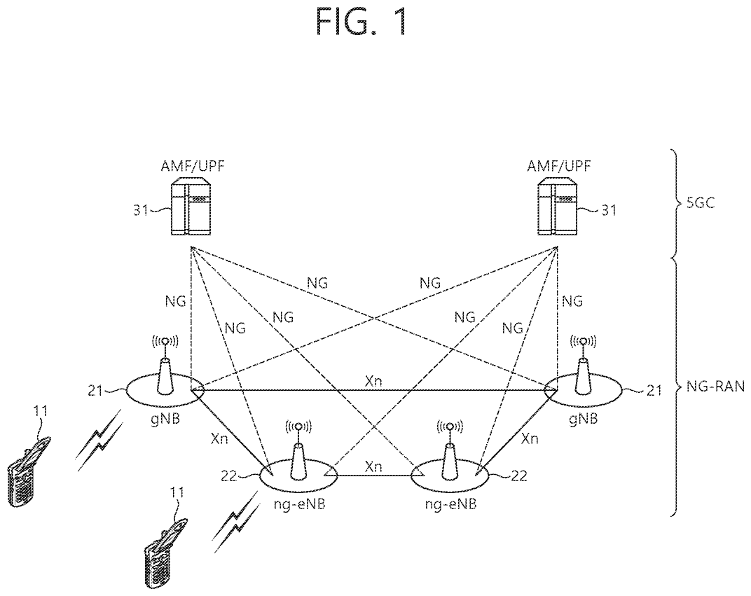

FIG. 1 shows another example of a wireless communication system to which a technical feature of the present disclosure can be applied.

Specifically, FIG. 1 shows a system architecture based on a 5G new radio access technology (NR) system. An entity used in the 5G NR system (hereinafter, simply referred to as “NR”) may absorb some or all functions of the entity (e.g., eNB, MME, S-GW) introduced in FIG. 1 (e.g., eNB, MME, S-GW). The entity used in the NR system may be identified in the name of “NG” to distinguish it from LTE.

Referring to FIG. 1, a wireless communication system includes one or more UEs 11, a next-generation RAN (NG-RAN), and a 5^{th} generation core network (5GC). The NG-RAN consists of at least one NG-RAN node. The NG-RAN node is an entity corresponding to the BS 20 of FIG. 1. The NG-RAN node consists of at least one gNB 21 and/or at least one ng-eNB 22. The gNB 21 provides NR user plane and control plane protocol terminations towards the UE 11. The Ng-eNB 22 provides an E-UTRA user plane and control plane protocol terminations towards the UE 11.

The 5GC includes an access and mobility management function (AMF), a user plane function (UPF), and a session management function (SMF). The AMF hosts functions, such as non-access stratum (NAS) security, idle state mobility processing, and so on. The AMF is an entity including the conventional MMF function. The UPF hosts functions, such as mobility anchoring, protocol data unit (PDU) processing, and so on. The UPF is an entity including the conventional S-GW function. The SMF hosts functions, such as UE Internet Protocol (IP) address allocation, PDU session control, and so on.

The gNB and the ng-eNB are interconnected through an Xn interface. The gNB and the ng-eNB are also connected to the 5GC through an NG interface. More specifically, the gNB and the ng-eNB are connected to the AMF through an NG-C interface, and are connected to the UPF through an NG-U interface.

The structure of a radio frame in NR is described. In LTE/LTE-A, one radio frame consists of 10 subframes, and one subframe consists of two slots. The length of one subframe may be 1 ms, and the length of one slot may be 0.5 ms. A time (generally over one subframe) for transmitting one transport block from a higher layer to a physical layer is defined as a transmission time interval (TTI). The TTI may be a minimum unit of scheduling.

Unlike LTE/LTE-A, NR supports various numerologies, so the radio frame structure may vary. NR supports multiple subcarrier spacing in the frequency domain. Table 1 shows several numerologies supported in NR. Each numerology can be identified by an index

TABLE 1

| | Subcarrier | | Support for | Support for |
|---|---|---|---|---|
| μ | spacing (kHz) | CP | data? | synchronization |
| 0 | 15 | normal CP | Yes | Yes |
| 1 | 30 | normal CP | Yes | Yes |
| 2 | 60 | normal/extended | Yes | No |
| | | CP | | |
| 3 | 120 | normal CP | Yes | Yes |
| 4 | 240 | normal CP | No | Yes |

Referring to Table 1, the subcarrier spacing may be set to one of 15, 30, 60, 120, and 240 kHz identified by the index However, the subcarrier spacing shown in Table 1 is merely exemplary, and the specific subcarrier spacing may be changed. Accordingly, each subcarrier interval (e.g., μ=0, 1, . . . 4) may be expressed as a first subcarrier interval, a second subcarrier interval . . . Nth subcarrier interval. Referring to Table 1, transmission of user data (e.g., a physical uplink shared channel (PUSCH) and a physical downlink shared channel (PDSCH)) may not be supported according to the subcarrier interval. That is, the transmission of user data may not be supported only in at least one specific subcarrier interval (e.g., 240 kHz).

In addition, referring to Table 1, a synchronization channel (PSS (primary synchronization signal), SSS (secondary synchronization signal), and PBCH (physical broadcasting channel) may not be supported depending on the subcarrier interval. That is, the synchronization channel may not be supported only in at least one specific subcarrier interval (e.g., 60 kHz).

In NR, the number of slots and the number of symbols included in one radio frame/subframe may vary according to various numerologies, that is, various subcarrier intervals. Table 2 shows examples of the number of OFDM symbols per slot, the number of slots per radio frame, and the number of slots per subframe in a general cyclic prefix (CP).

TABLE 2

| | Number of OFDM | Number of slots per | Number of slots per |
|---|---|---|---|
| μ | symbols per slot | radio frame | subframe |
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Referring to Table 2, when the first numerology corresponding to μ=0 is applied, one radio frame includes 10 subframes, one subframe corresponds to one slot, and one slot consists of 14 symbols. In this specification, a symbol represents a signal transmitted during a specific time interval. For example, a symbol may represent a signal generated by OFDM processing. That is, in this specification, a symbol may refer to an OFDM/OFDMA symbol or an SC-FDMA symbol. CP may be located between each symbol.

In the following, a physical channel and a signal transmission procedure will be described.

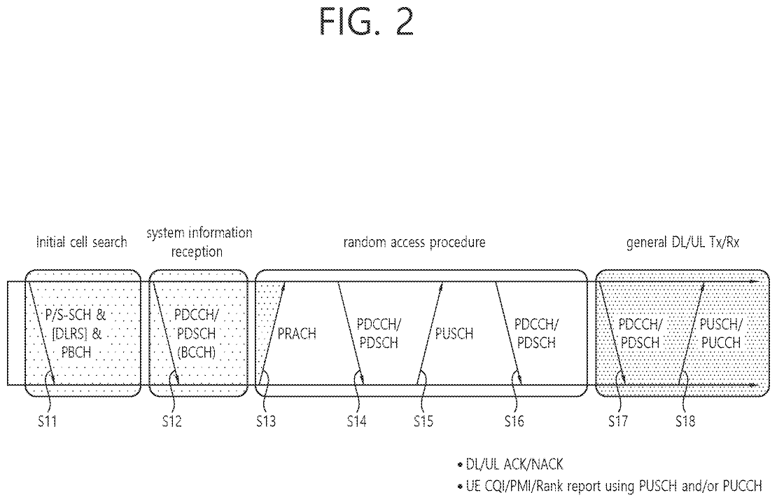

FIG. 2 illustrates physical channels used in the 3GPP system and a general signal transmission procedure.

In a wireless communication system, a UE receives information from a base station through downlink (DL) transmission, and the UE transmits information to the base station trough uplink (UL) transmission. The information transmitted and received between the base station and the UE includes data and various types of control information, and depending on the type/use of information transmitted and received between the base station and the UE, various physical channels are employed.

The UE, which is powered on again from a state in which the power is off or which newly enters a cell, may perform an initial cell search operation such as synchronizing with the base station S11. To this end, the UE may receive a Primary Synchronization Channel (PSCH) and a Secondary Synchronization Channel (SSCH) from the base station to synchronize with the base station and obtain information such as cell identity (ID). Also, the UE may receive a Physical Broadcast Channel (PBCH) from the base station to obtain broadcast information within the cell. Also, the UE may receive a Downlink Reference Signal (DL RS) in the initial cell search phase to check the downlink channel status.

After completing the initial cell search operation, the UE may receive a Physical Downlink Control Channel (PDCCH) and a Physical Downlink Shared Channel (PDSCH) corresponding thereto to obtain more specific system information S12.

Afterwards, the UE may perform a random access procedure to complete access to the base station S13-S16. More specifically, the UE may transmit an preamble through a Physical Random Access Channel (PRACH) S13 and receive a Random Access Response (RAR) to the preamble through the PDSCH corresponding to the PDCCH S14. Next, the UE may transmit a Physical Uplink Shared Channel (PUSCH) using scheduling information within the RAR S15 and perform a contention resolution procedure on the PDCCH and the PDSCH corresponding thereto S16.

The UE which has performed the procedure above may perform PDCCH/PDSCH reception S17 and PUSCH/Physical Uplink Control Channel (PUCCH) transmission S18 as a general uplink/downlink signal transmission procedure. The control information transmitted to the base station by the UE is called Uplink Control Information (UCI). The UCI may include Hybrid Automatic Repeat and reQuest Acknowledgement/Negative-ACK (HARQ ACK/NACK), a Scheduling Request (SR), and Channel State Information (CSI). The CSI includes a Channel Quality Indicator (CQI), a Precoding Matrix Indicator (PMI), and a Rank Indication (RI). The UCI is usually transmitted through the PUCCH but may be transmitted through the PUSCH when both of control information and data have to be transmitted simultaneously. Also, according to the request/instruction from a network, the UE may transmit the UCI aperiodically through the PUSCH.

In what follows, cell search will be described.

Cell search is a procedure in which a UE obtains time and frequency synchronization to a cell and detects a physical layer cell ID of the cell. To perform the cell search, the UE receives a Primary Synchronization Signal (PSS) and a Secondary Synchronization Signal (SSS).

The cell search procedure for a UE may be summarized as shown in Table 3.

TABLE 3

| | Signal type | Operation |
|---|---|---|
| Step 1 | PSS | Obtain SS/PBCH block (SSB) symbol timing |
| | | Search cell ID group for cell ID (3 |
| | | hypothesis) |
| Step 2 | SSS | Detect cell ID group (336 hypothesis) |
| Step 3 | PBCH DMRS | SSB index and half-frame index (detect slot |
| | | and frame boundary) |
| Step 4 | PBCH | Time information (80 ms, SFN, SSB index, |
| | | HF) |
| | | Configure RMSI CORESET/search space |
| Step 5 | PDCCH and | Cell access information |
| | PDSCH | RACH configuration |

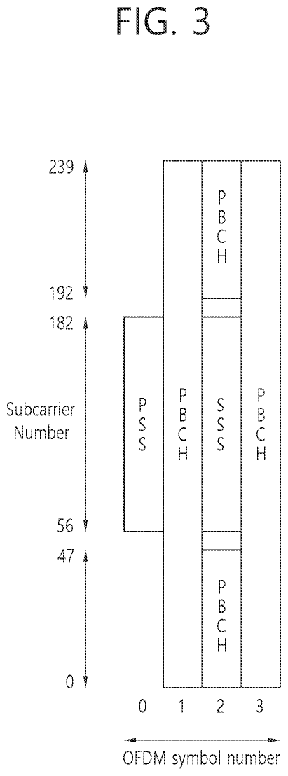

FIG. 3 illustrates a synchronization signal and PBCH (SS/PBCH) block. According to FIG. 3, an SS/PBCH block consists of a PSS and an SSS, each of which occupies one symbol and 127 subcarriers, and PBCHs occupying 3 OFDM symbols and 240 subcarriers, where one of the PBCHs has an unused region left for the SSS in the middle thereof The periodicity of the SS/PBCH block may be configured by the network, and the time position at which the SS/PBCH block may be transmitted is determined by subcarrier spacing.

Polar coding is used for the PBCH. Unless the network configures a UE to assume a different subcarrier spacing, the UE may assume a band-specific subcarrier spacing for the SS/PBCH block.

PBCH symbols carry their frequency-multiplexed DMRS. QPSK modulation is used for the PBCH.

1008 unique physical layer cell IDs are given by Eq. 1 below.

N_{ID}^{cell}=3N_{ID}⁽¹⁾+N_{ID}⁽²⁾ (1)

In Eq. 1, N_{ID}⁽¹⁾∈{0, 1, . . . , 335} and N_{ID}⁽²⁾∈{0, 1, 2}.

Meanwhile, a PSS sequence d_{PSS}(n) for PSS is defined by Eq. 2 as follows.

d_{PSS}(n)=1−2x(m) (2)

m=(n+43N_{ID}⁽²⁾) mod 127

0≤n<127

In Eq. 2, (x(i+7)=(x(i+4)+x(0) mod 2 and [x(6) x(5) x(4) x(3) x(2) x(1) x(0)]=[1 1 1 0 1 1 0].

The sequence may be mapped to the physical resources shown in FIG. 29.

Meanwhile, an SSS sequence d_{SSS}(n) for SSS is defined by Eq. 3 as follows.

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] {m}_{0} = 15 [ \frac{{N}_{ID}^{( 1 )}}{112} ] + 5 {N}_{ID}^{( 2 )} {m}_{1} = {N}_{ID}^{( 1 )} mod 112 \; 0 \leq n < 127 \qquad [ Eq . 3 ]$$

In Eq. 3, x₀(i+7)=(x₀(i+4)+x₀(i))mod 2, x₁(i+7)=(x₁(i+1)+x₁(i))mod 2, [x₀(6) x₀(5) x₀(4) x₀(3) x₀(2) x₀(1) x₀(0)]=[0 0 0 0 0 0 1], and [x₁(6) x₁(5) x₁(4) x₁(3) x₁(2) x₁(1) x₁(0)]=[0 0 0 0 0 0 1].

The sequence above may be mapped to the physical resources shown in FIG. 2.

For a half frame having SS/PBCH blocks, first symbol indexes for candidate SS/PBCH blocks may be determined by subcarrier spacing of the SS/PBCH blocks described later.

Case A—subcarrier spacing 15 kHz: The first symbols of candidate SS/PBCH blocks have an index of {2, 8}+14*n. For subcarrier frequencies below or equal to 3 GHz, n=0, 1. For subcarrier frequencies above 3 GHz and below or equal to 6 GHz, n=0, 1, 2, 3.

Case B—subcarrier spacing 30 kHz: The first symbols of candidate SS/PBCH blocks have an index of {4, 8, 16, 20}+28*n. For subcarrier frequencies below or equal to 3 GHz, n=0. For subcarrier frequencies above 3 GHz and below or equal to 6 GHz, n=0, 1.

Case C—subcarrier spacing 30 kHz: The first symbols of candidate SS/PBCH blocks have an index of {2, 8}+14*n. For subcarrier frequencies below or equal to 3 GHz, n=0, 1. For subcarrier frequencies above 3 GHz and below or equal to 6 GHz, n=0, 1, 2, 3.

Case D—subcarrier spacing 120 kHz: The first symbols of candidate SS/PBCH blocks have an index of {4, 8, 16, 20}+28*n. For subcarrier frequencies above 6 GHz, n=0, 1, 2, 3, 5, 6, 7, 8, 10, 11, 12, 13, 15, 16, 17, 18.

Case E—subcarrier spacing 240 kHz: The first symbols of candidate SS/PBCH blocks have an index of {8, 12, 16, 20, 32, 36, 40, 44}+56*n. For subcarrier frequencies above 6 GHz, n=0, 1, 2, 3, 5, 6, 7, 8.

The candidate SS/PBCH blocks within the half-block may be indexed on the time axis in an ascending order starting from 0 to L−1. From one-to-one mapping to the index of a DM-RS sequence transmitted within the PBCH, the UE has to determine 2 LSBs of the SS/PBCH block index for each half-frame when L=4 and 3 LSBs when L>4. When L=64, the UE has to determine 3 MSBs of the SS/PBCH block index for each half-frame according to the PBCH payload bits ā_{Ā+5}, ā_{Ā+6}, and ā_{Ā+7}.

The indexes of SS/PBCH blocks in which the UE is unable to receive other signals or channels within REs overlapping the REs corresponding to the SS/PBCH blocks may be configured for the UE by the upper layer parameter ‘SSB-transmitted-SIB1’. Also, the indexes of SS/PBCH blocks for each serving cell, in which the UE is unable to receive other signals or channels within REs overlapping the REs corresponding to the SS/PBCH blocks may be configured by the upper layer parameter ‘SSB-transmitted’. Configuration by ‘SSB-transmitted’ may have a higher priority than configuration by ‘SSB-transmitted-SIB1’. The UE may be configured with a periodicity of the half-frame for reception of SS/PBCH blocks for each serving cell by the upper layer parameter ‘SSB-periodicityServingCell’. If the UE is not configured with a periodicity of the half-frame for reception of SS/PBCH blocks, the UE may assume a periodicity of the half-frame. The UE may assume that the periodicity is the same for all of SS/PBCH blocks within a serving cell.

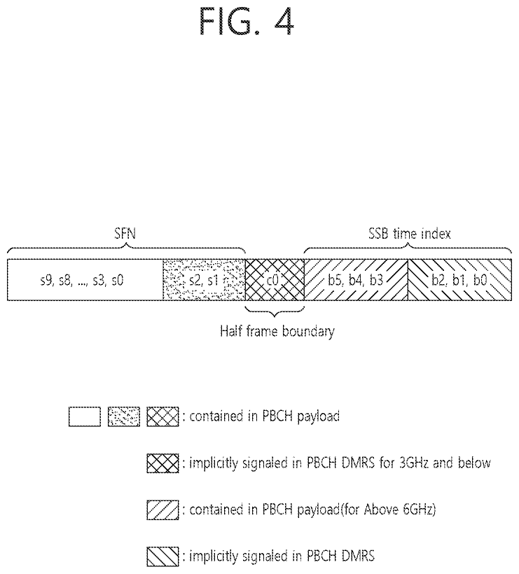

FIG. 4 illustrates a method for obtaining timing information by a UE.

First, the UE may obtain 6-bit SFN information through MasterInformationBlock (MIB) received within PBCH. Also, the UE may obtain 4-bit SFN information within a PBCH transport block.

Secondly, the UE may obtain a 1-bit half-frame indicator as part of a PBCH payload. Below 3 GHz, the half-frame indicator may be signaled implicitly as part of a PBCH DMRS when Lₘₐₓ=4.

Lastly, the UE may obtain an SS/PBCH block index by the DMRS sequence and the PBCH payload. In other words, the UE may obtain 3-bit LSBs of the SS block index by the DMRS sequence during a period of 5 ms. Also, (above 6 GHz) 3-bit MSBs of timing information are carried explicitly within the PBCH payload.

In the initial cell selection step, the UE may assume that a half-frame having SS/PBCH blocks is generated with a periodicity of 2 frames. If an SS/PBCH block is detected, and k_{SSB}≤23 for FR1 and k_{SSB}≤11 for FR2, the UE determines that there exists a set of control resources for Type0-PDCCH common search space. If k_{SSB}>23 for FR1 and k_{SSB}>11 for FR2, the UE determines that a set of control resources for the Type0-PDCCH common search space does not exist.

For a serving cell to which no SS/PBCH block is transmitted, the UE obtains time and frequency synchronization to the serving cell based on the reception of SS/PBCH blocks on the PCell or PSCell of a cell group for the serving cell.

In what follows, acquisition of System Information (SI) is described.

The System Information (SI) is divided into MasterInformationBlock (MIB) and a plurality of SystemInformationBlocks (SIBs), where
The MIB is always transmitted on the BCH with a periodicity of 80 ms and repetitions made within 80 ms, and it includes parameters needed to acquire SystemInformationBlockType1 (SIB1) from the cell;
SIB1 is transmitted on the DL-SCH with a periodicity and repetitions. SIB1 includes information about availability and scheduling (for example, periodicity and SI-window size) of other SIBs. Also, SIB1 indicates whether they (namely, other SIBs) are provided via periodic broadcast basis or only on-demand basis. If other SIBs are provided on-demand, SIB1 includes information required for the UE to perform an SI request;
SIBs other than the SIB1 are carried by SystemInformation (SI) messages transmitted on the DL-SCH. Each SI message is transmitted within periodically occurring time domain windows (which are referred to as SI-windows);
For PSCell and SCells, RAN provides the required SI by dedicated signaling. Nevertheless, the UE has to acquire the MIB of the PSCell to get SFN timing (which may be different from MCG) of the SCG. When relevant SI for SCell is changed, RAN releases and adds the concerned SCell. For PSCell, SI may only be changed only through reconfiguration with Sync.

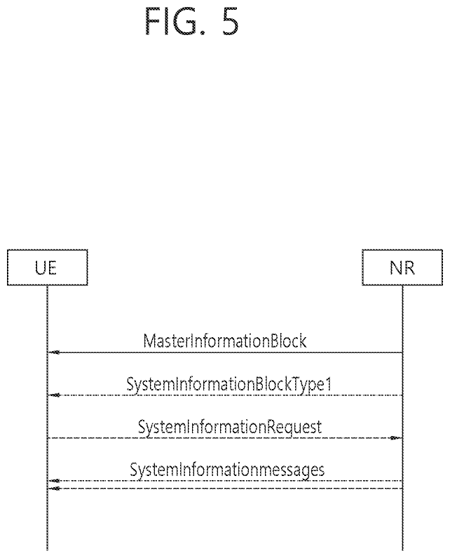

FIG. 5 illustrates one example of a system information acquisition procedure of a UE.

According to FIG. 5, the UE may receive MIB from the network and then may receive SIB1. Afterwards, the UE may transmit a system information request to the network and receive a SystemInformation message from the network in response to the request.

The UE may apply the system information acquisition procedure to acquire Access Stratum (AS) and Non-Access Stratum (NAS) information.

The UE in RRC IDLE and RRC INACTIVE state has to ensure having a valid version of (at least) the MIB, SIB1, and SystemInformationBlockTypeX (depending on the support of a concerned RAT for UE controlled mobility).

The UE in the RRC CONNECTED state has to ensure having a valid version of the MIB, SIB1, and SystemInformationBlockTypeX (depending on the mobility support for a concerned RAT).

The UE has to store relevant SI acquired from a currently camped/serving cell. A version of the SI that the UE has acquired and stored remains valid only for a certain time period. The UE may use such a stored version of the SI, for example, after cell re-selection, upon return from out of coverage or after SI change indication.

In what follows, Random Access (RA) will be described.

A random access procedure for a UE may be summarized as shown in Table 4.

TABLE 4

| | Signal type | Operation/Acquired information |
|---|---|---|
| Step 1 | PRACH preamble of | Acquisition of initial beam |
| | uplink | Random election of RA-preamble ID |
| Step 2 | Random access | Timing array information |
| | response on DL-SCH | RA-preamble ID |
| | | Initial uplink grant, temporary C- |
| | | RNTI |
| Step 3 | Uplink transmission | RRC connection request |
| | on UL-SCH | UE identity |
| Step 4 | Contention resolution | C-RNTI on PDCCH for initial access |
| | of downlink | C-RNTI on PDCCH for UE in the |
| | | RRC_CONNECTED state |

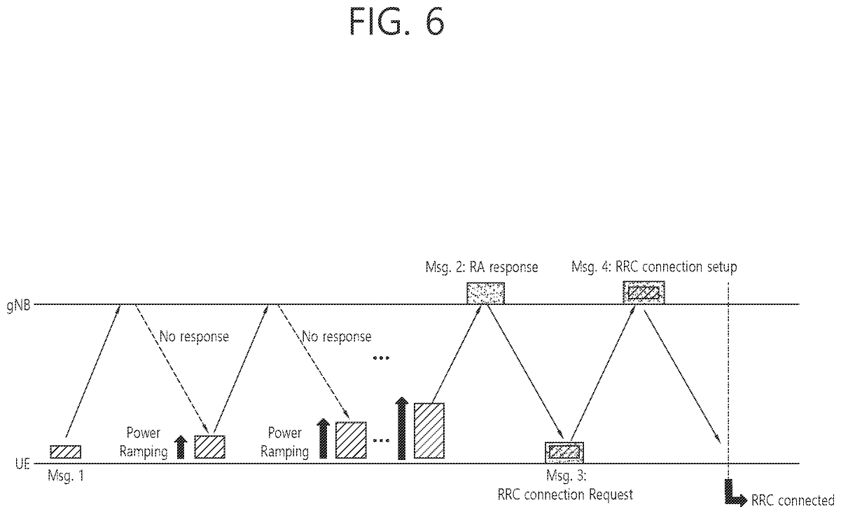

FIG. 6 illustrates a random access procedure. Referring to FIG. 6, first, a UE may transmit a PRACH preamble via uplink transmission as message 1 (Msg 1) of the random access procedure.

A random access preamble sequence having two different lengths may be supported. A long sequence of length 839 is applied to the subcarrier spacing of 1.25 kHz and 5 kHz, and a short sequence of length 139 is applied to the subcarrier spacing of 15, 30, 60, and 120 kHz. A long sequence supports an unrestricted set and a restricted set of type A and type B while a short sequence may support only the unrestricted set.

A plurality of RACH preambles may be defined by one or more RACH OFDM symbols, different Cyclic Prefix (CP), and guard time. Configuration of PRACH preamble to be used may be provided to the UE as system information.

When there is no response to Msg 1, the UE may re-transmit a PRACH preamble power-ramped within a specified number of times. The UE calculates PRACH transmission power for retransmission of the preamble based on the most recent estimated path loss and a power ramping counter. If the UE performs beam switching, the power ramping counter does not change.

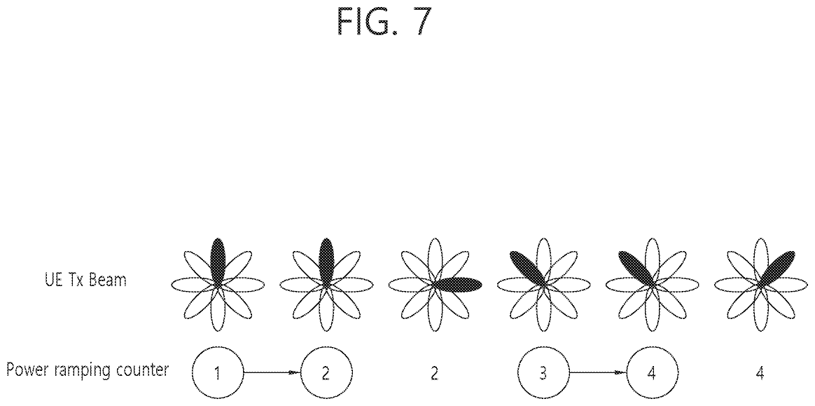

FIG. 7 illustrates a power ramping counter.

The UE may perform power ramping for retransmission of a random access preamble based on the power ramping counter. As described above, the power ramping counter does not change when the UE performs beam switching at the time of PRACH retransmission.

According to FIG. 7, when the UE retransmits a random access preamble for the same beam, such as when the power ramping counter increases from 1 to 2 and 3 to 4, the UE increases the power ramping counter by 1. However, when the beam is changed, the power ramping counter may not change at the time of PRACH retransmission.

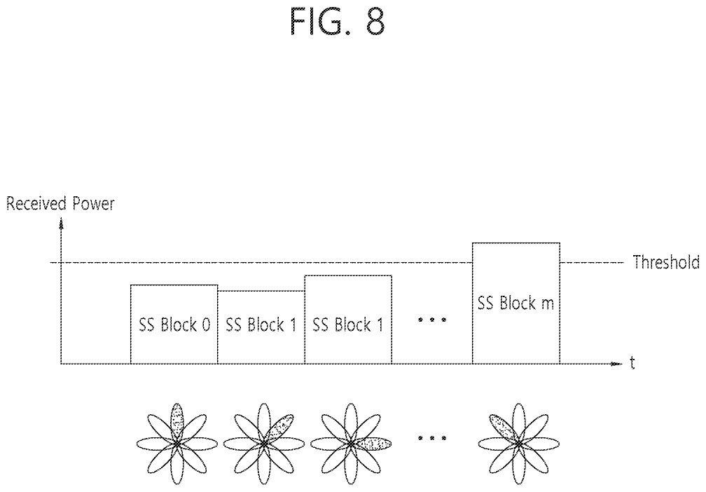

FIG. 8 illustrates a threshold of an SS block in the RACH resource relationship.

The system information may inform the UE of the relationship between SS blocks and RACH resources. The threshold of an SS block in the RACH resource relationship may be based on the RSRP and network configuration. Transmission and retransmission of the RACH preamble may be based on the SS block satisfying the threshold. Therefore, in the example of FIG. 8, since SS block m exceeds the threshold of receive power, the RACH preamble is transmitted or retransmitted based on the SS block m.

Afterwards, when the UE receives a random access response on the DL-SCH, the DL-SCH may provide timing array information, an RA-preamble ID, an initial uplink grant, and temporary C-RNTI.

Based on the information, the UE may perform uplink transmission on the UL-SCH as message 3 (Msg3) of the random access procedure. Msg3 may include an RRC connection request and a UE identity.

As a response to the uplink transmission, the network may transmit Msg4 that may be treated as a contention resolution message via downlink transmission. By receiving Msg4, the UE may enter the RRC connection state.

In what follows, the random access procedure will be described in more detail.

Before starting a physical random access procedure, layer 1 has to receive a set of SS/PBCH block indexes from the upper layer and provide a set of corresponding RSRP measurements to the upper layer.

Before starting the physical random access procedure, layer 1 has to receive the following information from the upper layer:
Configuration of PRACH transmit parameter (PRACH preamble format, time resources, and frequency resources for PRACH transmission) and
Parameter for determination of a root sequence and a cyclic shift (index of a logical root sequence table, cyclic shift (NCS), and set type (unrestricted set, restricted set A or restricted set B)) within the PRACH preamble sequence set for the parameter.

From the physical layer perspective, the L1 random access procedure includes transmission of random access preamble (Msg1) in a PRACH, Random Access Response (RAR) message (Msg2) with a PDCCH/PDSCH, and when applicable, Msg3 PUSCH; and transmission of PDSCH for contention resolution.

If the random access procedure is started by a PDCCH order to the UE, random access preamble transmission may have a subcarrier spacing which is the same as the subcarrier spacing of random access preamble transmission initiated by the upper layer.

When the UE is configured with two uplink subcarriers for a serving cell and the UE detects the PDCCH order, the UE may use a UL/SUL indicator field value from the detected PDCCH order to determine the uplink subcarrier for the corresponding random access preamble transmission.

In what follows, the random access preamble will be described in more detail.

In the random access preamble transmission step, the physical random access procedure may be triggered by an upper layer, a PDCCH order, or a request for PRACH transmission. Configuration of PRACH transmission by the upper layer may include the following:
Configuration about PRACH transmission; and
Preamble index, preamble subcarrier spacing, P_{PPRACH,target}, corresponding RA-RNTI, and PRACH resource.

The preamble may be transmitted according to a selected PRACH format having transmission power P_{PRACH,b,f,c(i)} on the indicated PRACH resource.

A plurality of SS/PBCH blocks related to one PRACH occasion may be provided to the UE by the upper layer parameter SSB-perRACH-Occasion. If SSB-perRACH-Occasion is smaller than 1, one SS/PBCH block may be mapped to contiguous PRACH occasions of 1/SSB-perRACH-Occasion. A plurality of preambles are provided to the UE for each SS/PBCH by the upper layer parameter cb-preamblePerSSB, and the UE may determine a multiple of SSB-perRACH-Occasion and the value of cb-preamblePerSSB as the total number of preambles for each PRACH and SSB.

The SS/PBCH block index may be mapped to the PRACH occasions according to the following order:
First, an ascending order of a preamble index within a single PRACH occasion,
Second, an ascending order of frequency resource index with respect to frequency multiplexed PRACH occasions,
Third, an ascending order of time resource index with respect to time multiplexed PRACH occasions within the PRACH slot, and
Fourth, an ascending order of index with respect to PRACH slots.

The period that starts from frame 0, at which SS/PBCH blocks are mapped to PRACH occasions, is the minimum value of the PRACH configuration periods {1, 2, 4}, which is larger than or equal to [N_{Tx}^{SSB}/N_{PRACHperiod}^{SSB}]; here, the UE obtains N_{Tx}^{SSB} by the upper layer parameter SSB-transmitted-SIB1, and N_{PRACHperiod}^{SSB} represents the number of SS/PBCH blocks that may be mapped to one PRACH configuration period.

If the random access procedure is started by the PDCCH order and is requested by the upper layer, the UE has to transmit the PRACH within the first available PRACH occasion, where the time difference between the last symbol at which the PDCCH order is received and the first symbol of PRACH transmission is larger than or equal to N_{T,2}+Δ_{BWPSwitching}+Δ_{Delay} msec. Here, N_{T,2} represents duration of N₂ symbols corresponding to PUSCH preparation time with respect to PUSCH processing capability 1, Δ_{BWPSwitching} is a predefined value, and Δ_{Delay}>0.

In what follows, a random access response will be described in more detail.

In response to the PRACH transmission, the UE may attempt to detect a PDCCH having the corresponding RA-RNTI during a window controlled by the upper layer. The window may start from the first symbol of the earliest control resource set configured for the

UE with respect to the Type 1-PDCCH common search space comprising at least

[(Δₛₗₒₜ^{subframe,μ}·N_{symb}^{slot})/T_{sf}] symbols after the last symbol of preamble sequence transmission. The length of the window as expressed in terms of the number of slots may be provided by the upper layer parameter rar-WindowLength based on the subcarrier spacing with respect to the Type0-PDCCH common search space.

If the UE detects a PDCCH having the corresponding RA-RNTI and the corresponding PDSCH including a DL-SCH transmission block within the window, the UE may transmit the transmission block to the upper layer. The upper layer may parse the transmission block with respect to the Random Access Preamble Identity (RAPID) related to the PRACH transmission. If the upper layer identifies RAPID within an RAR message(s) of the DL-SCH transmission block, the upper layer may indicate an uplink grant to the physical layer. This may be referred to as a Random Access Response (RAR) uplink grant in the physical layer. If the upper layer fails to identify the RAPID related to the PRACH transmission, the upper layer may instruct the physical layer to transmit the PRACH. The minimum time difference between the last symbol at which the PDSCH is received and the first symbol of the PRACH transmission is the same as N_{T,1}+Δ_{new}+0.5, where N_{T,1} represents the duration of N_{T,1} symbols corresponding to the PDSCH reception time with respect to the PDSCH processing capability 1 when an additional PDSCH DM-RS is configured, and Δ_{new}≥0.

For a detected SS/PBCH block or a received CSI-RS, the UE may have to receive the corresponding PDSCH including a PDCCH having the corresponding RA-RNTI and a DL-SCH transmission block having the same DM-RS antenna port Quasi Co-Location (QCL) characteristics. If the UE attempts to detect a PDCCH having the corresponding RA-RNTI as a response to PRACH transmission initiated by the PDCCH order, the UE may assume that the PDCCH and PDCCH order have the same DM-RS antenna port QCL characteristics.

The RAR uplink grant schedules PUSCH transmission of the UE (Msg3 PUSCH).

Configuration of the RAR uplink grant, which starts from the MSG and ends at the LSB, may be given as shown in Table 5. Table 5 shows the size of a random access response grant configuration field.

TABLE 5

| | Number of |
|---|---|
| RAR grant field | bits |
| Frequency hopping flag | 1 |
| Msg3 PUSCH frequency resource | 14 |
| allocation | |
| Msg3 PUSCH time resource allocation | 4 |
| MCS | 4 |
| TPC command for Msg3 PUSCH | 3 |
| CSI request | 1 |
| Reserved bits | 3 |

Msg3 PUSCH frequency resource allocation is related to uplink resource allocation type 1. In the case of frequency hopping, based on the indication of the frequency hopping flag field, the first or first two bits N_{UL,hop} of the Msg3 PUSCH frequency resource allocation field may be used as hopping information bits. MCS may be determined by the first 16 indexes of the MCS index table applicable to the PUSCH.

The TPC command δ_{msg2,b,f,c} may be used for power configuration of the Msg3 PUSCH and may be interpreted according to Table 11 below.

TABLE 6

| TPC Command | Value [dB] |
|---|---|
| 0 | −6 |
| 1 | −4 |
| 2 | 2 |
| 3 | 0 |
| 4 | 2 |
| 5 | 4 |
| 6 | 6 |
| 7 | 8 |

In a non-contention based random access procedure, the CSI request field is interpreted to determine whether a non-periodic CSI report is included in the corresponding PUSCH transmission. In the contention-based random access procedure, the CSI request field may be reserved. As long as the UE does not configure the subcarrier spacing, the UE receives a subsequent PDSCH by using the subcarrier spacing that is the same as PDSCH reception that provides an RAR message.

If the UE does not detect a PDCCH having the corresponding RA-RNTI within a window and the corresponding DL-SCH transmission block, the UE performs a random access response reception failure procedure.

In what follows, the Msg3 PUSCH transmission will be described in more detail.

With respect to Msg3 PUSCH transmission, the upper layer parameter msg3-tp indicates whether the UE has to apply a transform precoding for the Msg3 PUSCH transmission. If the UE applies a transform precoding for Msg3 PUSCH transmission employing frequency hopping, the frequency offset for the second hop may be given as shown in Table 7. Table 7 illustrates a frequency offset of the second hop with respect to the Msg3 PUSCH transmission employing frequency hopping.

TABLE 7

| Number of PRBs | | |
|---|---|---|
| in initial | Value of N_{UL, hop} | Frequency offset |
| active UL BWP | Hopping Bits | for 2nd hop |
| N_{BWP}^{size} < 50 | 0 | N_{BWP}^{size}/2 |
| | 1 | N_{BWP}^{size}/4 |
| N_{BWP}^{size} ≥ 50 | 00 | N_{BWP}^{size}/2 |
| | 01 | N_{BWP}^{size}/4 |
| | 10 | −N_{BWP}^{size}/4 |
| | 11 | Reserved |

The subcarrier spacing for Msg3 PUSCH transmission may be provided by the upper layer parameter msg3-scs. The UE has to transmit the PRACH and Msg3 PUSCH on the same uplink carrier of the same serving cell. The uplink BWP for the Msg3 PUSCH transmission may be indicated by SystemInformationBlockType1. When the PDSCH and PUSCH have the same subcarrier spacing, the minimum time difference between the last symbol at which the PDSCH carrying the RAR is received and the first symbol of the corresponding Msg3 PUSCH transmission scheduled by the RAR within the PDSCH with respect to the UE may be the same as N_{T,1}+N_{T,2}+N_{TA,max}+0.5 msec. Here, N_{T,1} represents the duration of N₁ symbols corresponding to the PDSCH reception with respect to the PDSCH processing capability 1 when an additional PDSCH DM-RS is configured, N_{T,2} represents the duration of N₂ symbols corresponding to the PUSCH preparation time with respect to the PUSCH processing capability 1, and N_{TA,max} represents the maximum timing adjustment value that may be provided by the TA command field within the RAR.

In what follows, contention resolution will be described in more detail.

If the UE fails to receive C-RNTI, the UE attempts to detect a PDCCH having the corresponding TC-RNTI that schedules a PDSCH including UE contention resolution identity in response to the Msg3 PUSCH transmission. In response to the reception of the PDSCH having the UE contention resolution identity, the UE transmits HARQ-ACK information within the PUCCH. The minimum time difference between the last symbol at which the PDSCH is received and the first symbol of the corresponding HARQ-ACK transmission is N_{T,1}+0.5 msec. N_{T,1} represents the duration of N₁ symbols corresponding to the PDSCH reception with respect to the PDSCH processing capability 1 when an additional PDSCH DM-RS is configured.

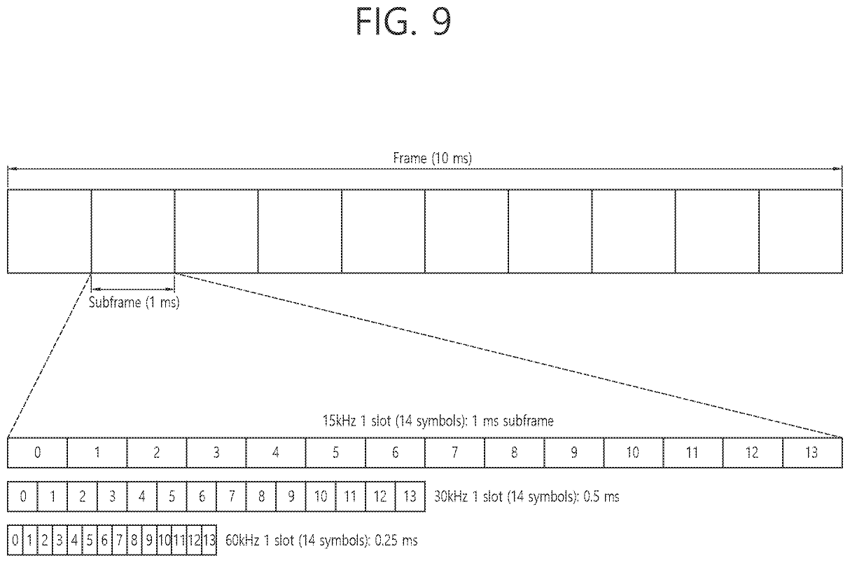

FIG. 9 illustrates an example of a frame structure that may be applied in NR.

Referring to FIG. 9, a frame may be composed of 10 milliseconds (ms) and include 10 subframes each composed of 1 ms.

One or a plurality of slots may be included in a subframe according to subcarrier spacings.

The following table 8 illustrates a subcarrier spacing configuration

TABLE 8

| μ | Δf = 2^{μ} · 15 [kHz] | Cyclic prefix |
|---|---|---|
| 0 | 15 | Normal |
| 1 | 30 | Normal |
| 2 | 60 | Normal |
| | | Extended |
| 3 | 120 | Normal |
| 4 | 240 | Normal |

The following table 9 illustrates the number of slots in a frame (N^{frame,∞}ₛₗₒₜ), the number of slots in a subframe (N^{subframe,μ}ₛₗₒₜ), the number of symbols in a slot (N^{slot}_{symb}), and the like, according to subcarrier spacing configurations μ.

TABLE 9

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

In FIG. 9, μ=0, 1, and 2 are illustrated. A physical downlink control channel (PDCCH) may include one or more control channel elements (CCEs) as illustrated in the following table.

TABLE 10

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through a resource including 1, 2, 4, 8, or 16 CCEs. Here, the CCE includes six resource element groups (REGs), and one REG includes one resource block in a frequency domain and one orthogonal frequency division multiplexing (OFDM) symbol in a time domain. In NR, the following technologies/features can be applied.

<Self-Contained Subframe Structure>

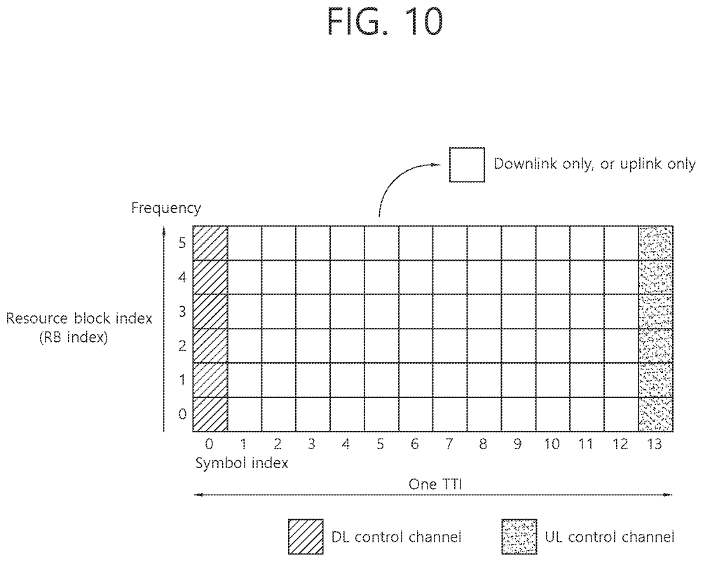

FIG. 10 illustrates an example of a frame structure for new radio access technology.

In NR, a structure in which a control channel and a data channel are time-division-multiplexed within one TTI, as shown in FIG. 10, can be considered as a frame structure in order to minimize latency.

In FIG. 10, a shaded region represents a downlink control region and a black region represents an uplink control region. The remaining region may be used for downlink (DL) data transmission or uplink (UL) data transmission. This structure is characterized in that DL transmission and UL transmission are sequentially performed within one subframe and thus DL data can be transmitted and UL ACK/NACK can be received within the subframe. Consequently, a time required from occurrence of a data transmission error to data retransmission is reduced, thereby minimizing latency in final data transmission.

In this data and control TDMed subframe structure, a time gap for a base station and a terminal to switch from a transmission mode to a reception mode or from the reception mode to the transmission mode may be required. To this end, some OFDM symbols at a time when DL switches to UL may be set to a guard period (GP) in the self-contained subframe structure.

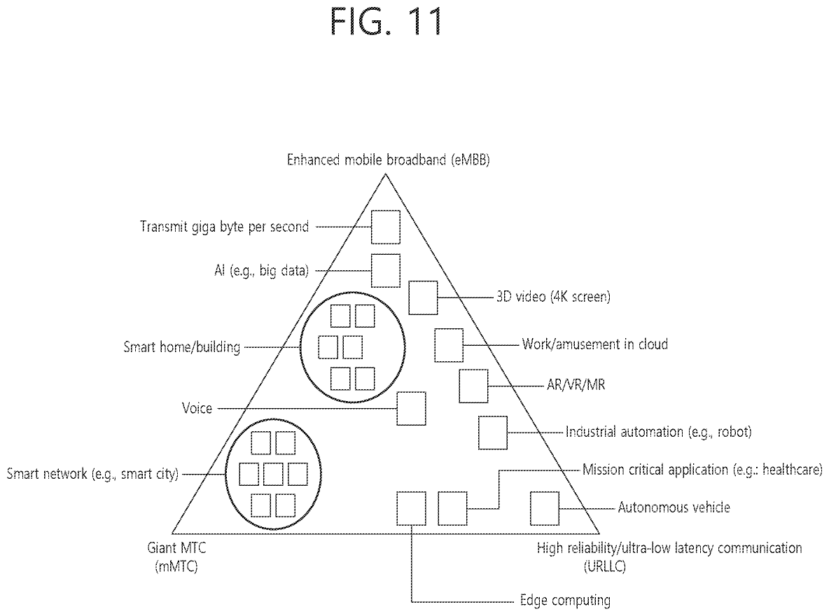

FIG. 11 shows examples of 5G usage scenarios to which the technical features of the present disclosure can be applied. The 5G usage scenarios shown in FIG. 11 are only exemplary, and the technical features of the present disclosure can be applied to other 5G usage scenarios which are not shown in FIG. 11.

Referring to FIG. 11, the three main requirements areas of 5G include (1) enhanced mobile broadband (eMBB) domain, (2) massive machine type communication (mMTC) area, and (3) ultra-reliable and low latency communications (URLLC) area. Some use cases may require multiple areas for optimization and, other use cases may only focus on only one key performance indicator (KPI). 5G is to support these various use cases in a flexible and reliable way.

eMBB focuses on across-the-board enhancements to the data rate, latency, user density, capacity and coverage of mobile broadband access. The eMBB aims ˜10 Gbps of throughput. eMBB far surpasses basic mobile Internet access and covers rich interactive work and media and entertainment applications in cloud and/or augmented reality. Data is one of the key drivers of 5G and may not be able to see dedicated voice services for the first time in the 5G era. In 5G, the voice is expected to be processed as an application simply using the data connection provided by the communication system. The main reason for the increased volume of traffic is an increase in the size of the content and an increase in the number of applications requiring high data rates. Streaming services (audio and video), interactive video and mobile Internet connectivity will become more common as more devices connect to the Internet. Many of these applications require always-on connectivity to push real-time information and notifications to the user. Cloud storage and applications are growing rapidly in mobile communication platforms, which can be applied to both work and entertainment. Cloud storage is a special use case that drives growth of uplink data rate. 5G is also used for remote tasks on the cloud and requires much lower end-to-end delay to maintain a good user experience when the tactile interface is used. In entertainment, for example, cloud games and video streaming are another key factor that increases the demand for mobile broadband capabilities. Entertainment is essential in smartphones and tablets anywhere, including high mobility environments such as trains, cars and airplanes. Another use case is augmented reality and information retrieval for entertainment. Here, augmented reality requires very low latency and instantaneous data amount.

mMTC is designed to enable communication between devices that are low-cost, massive in number and battery-driven, intended to support applications such as smart metering, logistics, and field and body sensors. mMTC aims ˜10 years on battery and/or ˜1 million devices/km2. mMTC allows seamless integration of embedded sensors in all areas and is one of the most widely used 5G applications. Potentially by 2020, IoT devices are expected to reach 20.4 billion. Industrial IoT is one of the areas where 5G plays a key role in enabling smart cities, asset tracking, smart utilities, agriculture and security infrastructures.

URLLC will make it possible for devices and machines to communicate with ultra-reliability, very low latency and high availability, making it ideal for vehicular communication, industrial control, factory automation, remote surgery, smart grids and public safety applications. URLLC aims ˜1 ms of latency. URLLC includes new services that will change the industry through links with ultra-reliability/low latency, such as remote control of key infrastructure and self-driving vehicles. The level of reliability and latency is essential for smart grid control, industrial automation, robotics, drones control and coordination.

Next, a plurality of use cases included in the triangle of FIG. 11 will be described in more detail.

5G can complement fiber-to-the-home (FTTH) and cable-based broadband (or DOCSIS) as a means of delivering streams rated from hundreds of megabits per second to gigabits per second. This high speed can be required to deliver TVs with resolutions of 4 K or more (6 K, 8 K and above) as well as virtual reality (VR) and augmented reality (AR). VR and AR applications include mostly immersive sporting events. Certain applications may require special network settings. For example, in the case of a VR game, a game company may need to integrate a core server with an edge network server of a network operator to minimize delay.

Automotive is expected to become an important new driver for 5G, with many use cases for mobile communications to vehicles. For example, entertainment for passengers demands high capacity and high mobile broadband at the same time. This is because future users will continue to expect high-quality connections regardless of their location and speed. Another use case in the automotive sector is an augmented reality dashboard. The driver can identify an object in the dark on top of what is being viewed through the front window through the augmented reality dashboard. The augmented reality dashboard displays information that will inform the driver about the object's distance and movement. In the future, the wireless module enables communication between vehicles, information exchange between the vehicle and the supporting infrastructure, and information exchange between the vehicle and other connected devices (e.g. devices accompanied by a pedestrian). The safety system allows the driver to guide the alternative course of action so that he can drive more safely, thereby reducing the risk of accidents. The next step will be a remotely controlled vehicle or self-driving vehicle. This requires a very reliable and very fast communication between different self-driving vehicles and between vehicles and infrastructure. In the future, a self-driving vehicle will perform all driving activities, and the driver will focus only on traffic that the vehicle itself cannot identify. The technical requirements of self-driving vehicles require ultra-low latency and high-speed reliability to increase traffic safety to a level not achievable by humans.

Smart cities and smart homes, which are referred to as smart societies, will be embedded in high density wireless sensor networks. The distributed network of intelligent sensors will identify conditions for cost and energy-efficient maintenance of a city or house. A similar setting can be performed for each home. Temperature sensors, windows and heating controllers, burglar alarms and appliances are all wirelessly connected. Many of these sensors typically require low data rate, low power and low cost. However, for example, real-time HD video may be required for certain types of devices for monitoring.

The consumption and distribution of energy, including heat or gas, is highly dispersed, requiring automated control of distributed sensor networks. The smart grid interconnects these sensors using digital information and communication technologies to collect and act on information. This information can include supplier and consumer behavior, allowing the smart grid to improve the distribution of fuel, such as electricity, in terms of efficiency, reliability, economy, production sustainability, and automated methods. The smart grid can be viewed as another sensor network with low latency.

The health sector has many applications that can benefit from mobile communications. Communication systems can support telemedicine to provide clinical care in remote locations. This can help to reduce barriers to distance and improve access to health services that are not continuously available in distant rural areas. It is also used to save lives in critical care and emergency situations. Mobile communication based wireless sensor networks can provide remote monitoring and sensors for parameters such as heart rate and blood pressure.

Wireless and mobile communications are becoming increasingly important in industrial applications. Wiring costs are high for installation and maintenance. Thus, the possibility of replacing a cable with a wireless link that can be reconfigured is an attractive opportunity in many industries. However, achieving this requires that wireless connections operate with similar delay, reliability, and capacity as cables and that their management is simplified. Low latency and very low error probabilities are new requirements that need to be connected to 5G.

Logistics and freight tracking are important use cases of mobile communications that enable tracking of inventory and packages anywhere using location based information systems. Use cases of logistics and freight tracking typically require low data rates, but require a large range and reliable location information.

Hereinafter, proposals of the present disclosure will be described.

Additional advantages, objects and features of the present disclosure will be set forth in part in the description that follows. Also, it will be apparent to or partially learning from the practice of the present disclosure to those skilled in the art upon review of the following. The objects and other advantages of the present disclosure may be realized and attained by means of the appended drawings as well as the appended claims and the structures particularly pointed out in the claims.

In the LTE system, a dormant state is defined to quickly perform activation/deactivation of a secondary cell (hereinafter referred to as SCell). When a specific SCell is set to a dormant state, the UE may not perform PDCCH monitoring for the corresponding cell. Thereafter, in order to quickly activate the corresponding SCell, it is defined to monitor the channel condition and link status of a corresponding cell by performing measurement and report in the dormant state. For example, when a specific SCell is set to a dormant state, the UE does not perform PDCCH monitoring, but may perform measurement and reporting for CSI/RRM.

In the NR system, a plurality of (e.g., up to 4) BWPs (bandwidth parts) may be configured for each serving cell, and the dormant state in the NR system is considering operation in units of BWP. Accordingly, a dormancy operation for each cell and/or BWP needs to be defined.

Method 1) State Change

The network may indicate a transition to a dormant state for a specific BWP, and the UE may not perform a part or all of the PDCCH monitoring configured in the BWP indicated to transition to the dormant state.

Method 2) Dormant BWP

The network may designate a specific BWP as a dormant BWP. For example, the BWP having a bandwidth of 0 may be configured, the minimum PDCCH monitoring may be indicated through the BWP configuration, or the PDCCH monitoring may not be indicated (by not indicating the SS set configuration).

In summary, in the NR system, a plurality of BWPs may be configured in one cell, and this may also be the case on the SCell. In other words, a plurality of BWPs may be configured in the SCell.

Herein, some of the plurality of BWPs in the SCell may be configured as dormant BWPs, and others may be configured as default BWPs. In this connection, on the dormant BWP, as described above, the UE may stop monitoring the PDCCH. In contrast, on the dormant BWP, when configured, the UE may continue to perform CSI measurement, automatic gain control (AGC), and/or beam management.

Additionally, the NR system considers a transition between a normal state and a dormant state through L1 signaling (e.g., using DCI) for faster SCell activation/deactivation. For example, the dormancy operation of a specific cell may be activated/deactivated through the following methods.

Method 1) Introduction of special DCI

A special DCI for indicating dormancy behavior of each SCell may be defined. For example, the UE may be indicated to monitor for a special DCI in the PCell, and the network may determine whether each SCell is dormancy through the special DCI. The dormancy behavior of the SCell may be defined using the above method 1 or 2, etc.

Method 2) Enhancement of BWP indication field in DCI

It is possible to extend a BWP indication field of the existing DCI to perform the BWP indication of the corresponding cell and/or a specific SCell(s) (that is, performing a cross-carrier indication for BWP in the existing BWP indication field).

Method 3) BWP level cross-carrier scheduling

The existing cross-carrier scheduling performs inter-carrier pairing in such a way that each cell indicates whether the corresponding cell is a scheduling/scheduled cell, and in the case of a scheduled cell, each cell indicates a scheduling cell of the corresponding cell. In order to define dormancy behavior for the SCell, a method of indicating whether cross-carrier scheduling for each BWP may be considered. For example, in each BWP configuration of the SCell, a scheduling cell that may be indicated to change a state, etc. when the corresponding BWP performs dormancy behavior may be designated. Alternatively, when a dormant BWP is designated, a scheduling cell indicating the dormancy behavior of the corresponding BWP in the corresponding BWP configuration may be designated.

In summary, in the NR system, a method of using DCI for dormant activation/deactivation operation may be provided. In this connection, a dormant BWP among a plurality of BWPs on the SCell may be activated/deactivated through DCI.

As stated above, various methods are being discussed to implement SCell fast activation/deactivation and dormancy behavior in NR. When the above methods are used, additional considerations may be as follows.

Issue 1) Default BWP triggered by BWP inactivity timer

Issue 2) Scheduling information within a DCI triggering dormancy behavior

Issue 3) HARQ feedback of a DCI triggering dormancy behavior

Each issue and solution are discussed below.

In the present specification, D-BWP may mean a BWP performing dormancy behavior, and N-BWP may mean a BWP performing an existing BWP operation as a normal BWP. In addition, in the present disclosure, dormant behavior in a certain BWP does not receive PDCCH in the corresponding BWP or receives it at a longer period than normal behavior, or does not receive PDSCH/PUSCH scheduling for the corresponding BWP, or it may mean that it is received in a longer period than normal behavior. Similarly, the dormant BWP may mean not receiving PDCCH in the corresponding BWP or receiving it at a longer period than normal BWP, or receiving no PDSCH/PUSCH scheduling for the corresponding BWP or receiving it at a longer period than normal BWP.

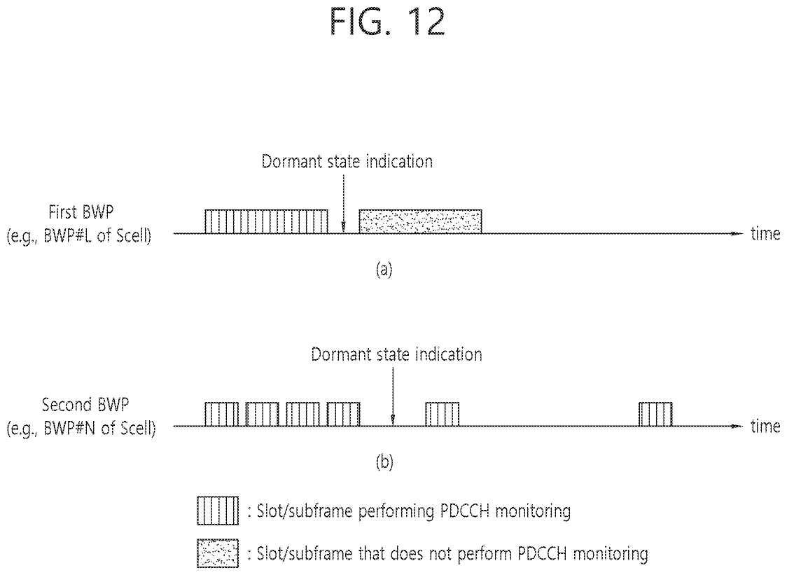

FIG. 12 illustrates dormant behavior.

As exemplified in FIG. 12(A), the UE may not perform PDCCH monitoring thereafter when receiving a dormant state indication while performing PDCCH monitoring in the first BWP. Alternatively, as exemplified in FIG. 12(B), while performing PDCCH monitoring in a first period in the second BWP, when a dormant state is indicated, thereafter, PDCCH monitoring may be performed in a second period. In this connection, the second period may be longer than the first period.

<Default BWP Triggered by BWP Inactivity Timer>

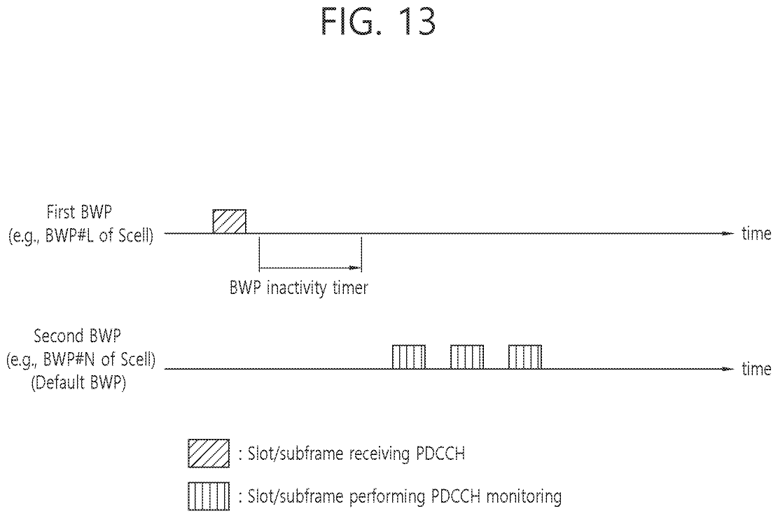

FIG. 13 illustrates an example of the BWP operation of the UE.

In the BWP operation of Rel-15, a BWP inactivity timer was introduced to prevent the case of configuring different active BWPs due to misunderstanding between the UE and the network. When the UE does not receive the PDCCH for more than a specific time (specified by the timer) in the active BWP, it may move to the default BWP indicated in advance by the network, and PDCCH monitoring in the default BWP may be performed according to the configured PDCCH monitoring configuration (e.g., CORESET, SS set configuration) for the default BWP. This operation is exemplified in FIG. 13.

When such a default BWP operation and dormancy behavior are performed together, an operation contrary to each purpose may be performed. For example, the network may indicate a specific SCell to move to D-BWP for power saving of the UE, or to change the current BWP to a dormant state. However, the UE that has configured for a BWP inactivity timer may move to the default BWP after a certain period of time to perform PDCCH monitoring.

A simple way to solve this is to consider a method of configuring the default BWP to D-BWP. However, in this case, an additional method is required to solve misunderstanding between the network and the UE, which is the original purpose of the default BWP.

In this regard, the present specification proposes the following method to apply dormancy behavior and BWP inactivity timer together.

When the network indicates the movement to D-BWP, or the current active BWP is switched to the dormant state, the UE ignores the presently configured BWP inactivity timer, or the inactivity timer may be reset as a predefined value or a value indicated by the network (for dormancy behavior).

In summary, according to an embodiment of the present specification, the active dormant BWP and the default BWP may be different BWPs. In addition, when the active dormant BWP is not the default BWP, the BWP inactivity timer may not be used based on the activation of the dormant BWP. In other words, when the active dormant BWP is not the default BWP (even when it is desirable for the UE to be in the dormant BWP for power saving, to prevent the inefficiency of forcibly transitioning to the default BWP by the BWP inactivity timer), based on the activation of the dormant BWP, the BWP inactivity timer, which is a timer for a transition to a default BWP, may not be used.

In addition, as described above, the dormant BWP and the default BWP may be BWPs on the SCell. From this viewpoint, the above description is once again explained as follows. When the active DL BWP indicated (or provided) as dormant BWP for a UE on an activated SCell is not a default BWP for the UE on the activated SCell, the BWP inactivity timer may not be used for a transition from the active DL BWP indicated (or provided) as the dormant BWP to the default DL BWP on the activated SCell.

For example, the network may configure an appropriate dormancy section in consideration of the UE's traffic situation, etc., and may indicate the UE (in advance) of the corresponding value. Thereafter, when the UE is indicated to move to the D-BWP or is indicated to switch the current active BWP to the dormant state, the UE may configure the value indicated by the network as the BWP inactivity timer value. In addition, the inactivity timer for dormancy behavior indicated by the network may operate independently of the existing BWP inactivity timer. For example, the UE indicated for the dormancy behavior may turn off the existing BWP inactivity timer and operate the inactivity timer for the dormancy behavior. Thereafter, when the BWP inactivity timer is terminated or the UE is indicated to move to the N-BWP (or switching to the normal state), the dormancy behavior may be terminated.

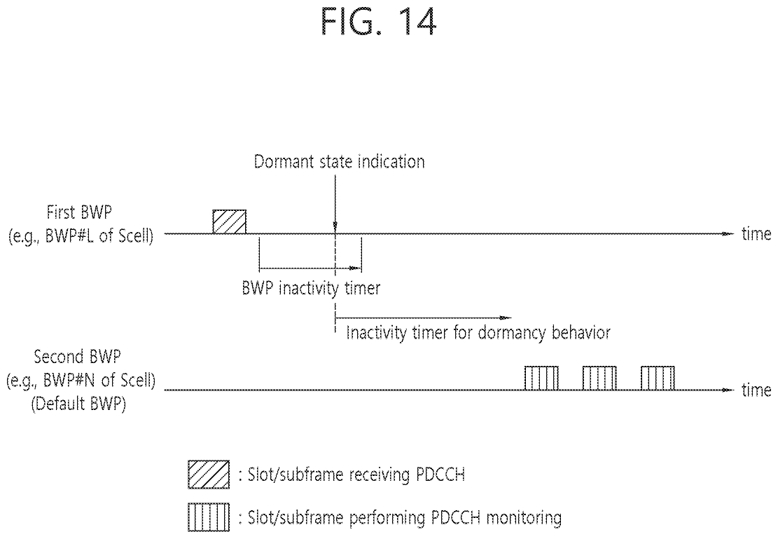

FIG. 14 illustrates another example of the BWP operation of the UE.

In addition, when the dormancy behavior is terminated by the inactivity timer for the dormancy behavior, the UE may move to the default BWP of the corresponding cell or switch to a normal state. Alternatively, when the network terminates dormancy behavior by the inactivity timer, the UE may designate and indicate the BWP to move. This operation is illustrated in FIG. 14.

<Scheduling Information Within a DCI Triggering Dormancy Behavior>

When the movement between D-BWP/N-BWP is indicated by DCI, and the corresponding DCI is a general scheduling DCI, a problem may occur when it is not clear whether the scheduling information in the DCI operates. For example, when performing an operation for PDSCH scheduling in DCI indicating movement to D-BWP, additional operation may be required depending on whether the reception of the corresponding PDSCH is successful. This may mean that the PDCCH/PDSCH transmission/reception operation may continue even in the D-BWP. In order to solve such a problem, the present disclosure proposes the following method.

Case 1) When PDSCH scheduling information exists in DCI indicating dormancy behavior for a specific cell (or DCI indicating switching to dormant BWP)

As described above, since PDSCH transmission/reception in D-BWP may cause additional PDCCH/PDSCH transmission/reception, an operation contrary to the purpose of dormant BWP may be performed. Accordingly, PDSCH scheduling information for D-BWP included in DCI indicating dormancy behavior may be ignored. In addition, the decoding performance of the UE may be improved by transmitting a known bit (sequence) to the corresponding field. For this purpose, known bit information for (the field related to PDSCH scheduling) may be indicated by the network or through previous definition.

Case 2) When PDSCH scheduling (or UL scheduling) information exists in DCI (or DCI indicating switching from dormant BWP to normal BWP) indicating the switching from dormancy behavior to normal behavior

In the case of case 2, since PDSCH scheduling information (or UL scheduling information) may reduce PDCCH transmission in N-BWP or in a normal state, it may be desirable to apply PDSCH scheduling information. However, case 2 may determine whether PDSCH scheduling information (or UL scheduling information) is applied while being limited to the case of UL/DL scheduling related information in the N-BWP to which the corresponding PDSCH scheduling information (or UL scheduling information) is switched or PDSCH (or UL transmission) related information in the normal state. For example, when a field indicating dormancy behavior for a specific SCell(s) is added to DCI for scheduling PDSCH of PCell, the PDSCH scheduling information of the corresponding DCI may also mean PDSCH-related information in the PCell.

<HARQ Feedback of a DCI Triggering Dormancy Behavior>

Since the dormancy behavior may limit the PDCCH/PDSCH transmission/reception operation in the indicated cell as much as possible (according to the definition), subsequent operations of the network and the UE may be greatly affected by missing/false alarms, etc. In order to solve this problem, a method of improving decoding performance may be applied or an additional identification operation for the dormancy behavior indication may be required. In order to solve this problem, the present specification proposes to perform ACK/NACK feedback for the movement to the D-BWP or the switching to the dormant state.

To this end, the following method may be considered. The options below may be implemented alone or in combination. In the following, when DCI is configured only with an indication of dormancy behavior (since the UE may not determine whether NACK is present), the following proposal may be interpreted as transmitting ACK signaling. Alternatively, when DCI indicating dormancy behavior also includes PDSCH scheduling, it may mean that ACK/NACK (uplink transmission in case of uplink scheduling) for the corresponding PDSCH has received a command for dormancy behavior. (In other words, since both ACK and NACK may mean that DCI reception is normally received, both ACK/NACK may mean that an indication for dormancy behavior has been received.)

Case 1) Dormancy Command+UL/DL Scheduling

DCI indicating dormancy behavior may include UL/DL scheduling information, and scheduled UL transmission and ACK/NACK for DL may mean that DCI including dormancy behavior has been properly received, and thus the UE and the network may assume that the indicated dormancy behavior is performed. (Herein, since NACK means NACK for PDSCH reception, NACK may also mean that an indication for dormancy behavior has been received.)

Case 1-1) When the Target of UL/DL Scheduling is Dormancy BWP (or Dormant State)

It may be assumed that the UE may perform dormancy behavior after termination of the scheduled UL/DL scheduling, and it may be assumed that the ACK/NACK resource (or UL resource) for the corresponding scheduling in D-BWP (or dormant state) follows the existing ACK/NACK resource determination method and UL transmission method. After terminating the corresponding UL/DL transmission/reception, the UE may perform dormancy behavior, and may assume that there is no scheduling thereafter or ignore it.

Case 1-2) When the Target of UL/DL Scheduling is Scheduling Cell/BWP (or Normal State)

In this case, ACK/NACK or UL transmission in the scheduling cell/BWP (or normal state) may mean that the dormancy command is normally received, and the UE may perform dormancy behavior.

Case 2) Dormancy Command+Non-Scheduling/Fake-Scheduling

Case 2 is a case in which dormancy behavior is indicated by DCI (or DCI that may assume the scheduling information field as a dummy) in which only the command for dormancy behavior is valid without UL/DL scheduling information. In this case, because there is no associated UL/DL transmission/reception, feedback information about DCI (when DCI is not received, the UE does not know whether DCI is transmitted, so it may actually mean ACK transmission) may be transmitted. In this case, feedback for the dormancy command is transmitted in the dormancy BWP (or dormant state), and the feedback resource is indicated together by DCI for transmitting the dormancy command, or feedback may be performed through a predefined feedback resource.

The effects that can be obtained through a specific example of the present specification are not limited to the effects listed above. For example, there may be various technical effects that a person having ordinary skill in the related art can understand or derive from the present specification. Accordingly, specific effects of the present specification are not limited to those explicitly described in the present specification, and may include various effects that can be understood or derived from the technical features of the present specification.

When the embodiments of the present specification described above are once again described with reference to the drawings, they may be organized as follows.

Hereinafter, embodiments of the present specification will be described with reference to the drawings. The following drawings were created to explain a specific example of the present specification. The names of specific devices described in the drawings or the names of specific signals/messages/fields are presented by way of example, so that the technical features of the present specification are not limited to the specific names used in the following drawings.

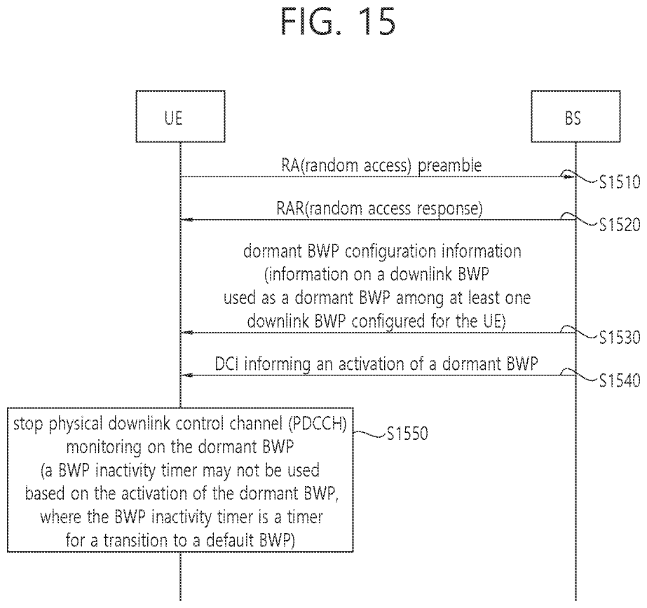

FIG. 15 is a flowchart of an initial access method according to an embodiment of the present disclosure.

Referring to FIG. 15, a user equipment (UE) may transmit a random access (RA) preamble to a base station (S1510). Specific examples for this are the same as described above, and thus repeated description will be omitted.

The UE may receive a random access response (RAR) from the base station (S1520). Specific examples for this are the same as above, and thus repeated description will be omitted.

The UE may receive dormant bandwidth part (BWP) configuration information from the base station (S1530). Herein, the dormant BWP configuration information is information on a downlink BWP used as a dormant BWP among at least one downlink BWP configured for the UE.

As an example, dormant BWP configuration information received by the terminal may be, for example, ‘dormantBWP-Id’. Here, the dormant BWP configuration information may include identification information(s) of the downlink BWP used as the dormant BWP. In this case, the identification information of the dormant BWP may be different from the identification information of the default BWP (in other words, the dormant BWP may be a different BWP from the default BWP).

Also, for example, the dormant BWP configuration information received by the terminal may be transmitted through a higher layer signaling (e.g., a RRC signaling).

The UE may receive downlink control information informing an activation of the dormant BWP from the base station (S1540).

For example, the DCI may include a BWP indicator field. Here, as an example, the BWP indicator field included in the DCI may indicate an active downlink BWP among the configured downlink BWPs, and since the dormant BWP corresponds to a type of downlink BWP, the active dormant BWP may also be indicated by the BWP indicator field.

In addition, as an example, DCI may correspond to, for example, DCI format 1_1 or DCI format 1_2, and DCI may be transmitted through L1 signaling.

The UE may stop physical downlink control channel (PDCCH) monitoring on the dormant BWP (S1550). Herein, a BWP inactivity timer may not be used based on the activation of the dormant BWP, where the BWP inactivity timer is a timer for a transition to a default BWP.

As an example, the terminal may receive information about the value of the BWP inactivity timer from the base station. In this case, the information received by the terminal may be, for example, ‘bwp-InactivityTimer’.

Here, for example, when the duration for the value of the BWP inactivity timer elapses, the terminal may fall back to the default BWP. In other words, when the BWP inactivity timer expires, the terminal may transition from the current BWP to the default BWP.

For example, if the network releases configuration information for the BWP inactivity timer, the terminal may stop the timer without switching to the default BWP.

Meanwhile, in this embodiment, as an example, the terminal may continue to perform CSI (channel state information) measurement on the dormant BWP. Specific examples thereof are the same as described above, and thus, repeated descriptions will be omitted.

For example, the default BWP may be a BWP to which the terminal transitions when the BWP inactivity timer expires. Specific examples thereof are the same as described above, and thus, repeated descriptions will be omitted.

For example, the dormant BWP may be a different BWP from the default BWP. Here, on the basis that the dormant BWP is not the default BWP, the BWP inactivity timer may not be used. Specific examples thereof are the same as described above, and thus, repeated descriptions will be omitted.

As an example, based on the activation of the dormant BWP and running of the BWP inactivity timer, the terminal may stop the BWP inactivity timer. Specific examples thereof are the same as described above, and thus, repeated descriptions will be omitted.

For example, based on the release of the BWP inactivity timer, the terminal may stop the BWP inactivity timer without transitioning to the default BWP. Specific examples thereof are the same as described above, and thus, repeated descriptions will be omitted.

For example, the at least one downlink BWP may be a downlink BWP for a secondary cell (SCell). Here, the at least one BWP may include the dormant BWP. Here, the at least one BWP may include the default BWP. Specific examples thereof are the same as described above, and thus, repeated descriptions will be omitted.

Meanwhile, the contents of the above-described embodiments may be described from a different perspective as follows.

The following drawings were created to explain a specific example of the present specification. Since the names of specific devices described in the drawings or the names of specific signals/messages/fields are presented by way of example, the technical features of the present specification are not limited to the specific names used in the following drawings.

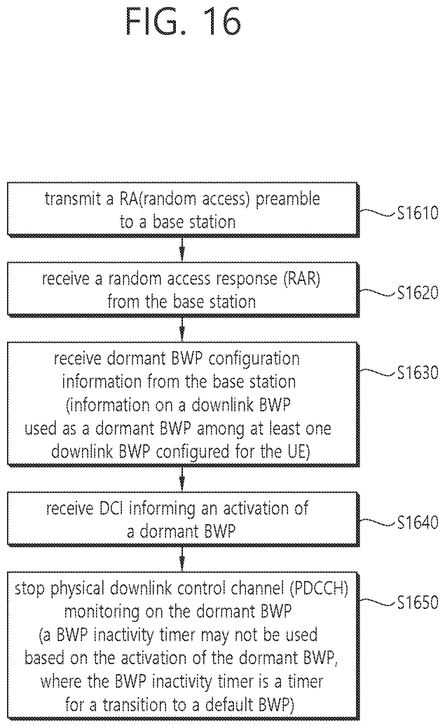

FIG. 16 is a flowchart of an initial access method from the viewpoint of a terminal, according to an embodiment of the present specification.

Referring to FIG. 16, a random access (RA) preamble may be transmitted to the base station (S1610). Since a more specific example of this example is the same as described above, in order to avoid unnecessary repetition of the description, the repetition description of the overlapping content will be omitted.

The terminal may receive a random access response (RAR) from the base station (S1620). Since a more specific example of this example is the same as described above, in order to avoid unnecessary repetition of the description, the repetition description of the overlapping content will be omitted.

The terminal may receive dormant bandwidth part (BWP) configuration information from the base station (S1630). Here, the dormant BWP configuration information may be information on a downlink BWP used as a dormant BWP among at least one downlink BWP configured for the terminal. Since a more specific example of this example is the same as described above, in order to avoid unnecessary repetition of the description, the repetition description of the overlapping content will be omitted.

The terminal may receive from the base station downlink control information (DCI) indicating activation of the dormant BWP (S1640). Since a more specific example of this example is the same as described above, in order to avoid unnecessary repetition of the description, the repetition description of the overlapping content will be omitted.

The terminal may stop monitoring a physical downlink control channel (PDCCH) on the dormant BWP (S1650). Here, based on the activation of the dormant BWP, the BWP inactivity timer, which is a timer for transition to the default BWP, may not be used. Since a more specific example of this example is the same as described above, in order to avoid unnecessary repetition of the description, the repetition description of the overlapping content will be omitted.

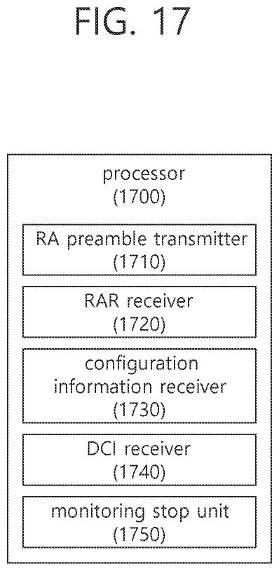

FIG. 17 is a block diagram of an example of an initial access device from the viewpoint of a terminal, according to an embodiment of the present disclosure.

Referring to FIG. 17, a processor 1700 may include a RA preamble transmitter 1710, a RAR receiver 1720, a configuration information receiver 1730, a DCI receiver 1740, and a monitoring stop unit 1750. Here, the processor 1700 may correspond to a processor to be described later (or described above).

The RA preamble transmitter 1710 may be configured to control the transceiver to transmit a random access (RA) preamble to the base station. Since a more specific example of this example is the same as described above, in order to avoid unnecessary repetition of the description, the repetition description of the overlapping content will be omitted.

The RAR receiver 1720 may be configured to control the transceiver to receive a random access response (RAR) from the base station. Since a more specific example of this example is the same as described above, in order to avoid unnecessary repetition of the description, the repetition description of the overlapping content will be omitted.

The configuration information receiving unit 1730 may be configured to control the transceiver to receive dormant bandwidth part (BWP) configuration information from the base station. Here, the dormant BWP configuration information may be information on a downlink BWP used as a dormant BWP among at least one downlink BWP configured for the terminal. Since a more specific example of this example is the same as described above, in order to avoid unnecessary repetition of the description, the repetition description of the overlapping content will be omitted.

The DCI receiver 1740 may be configured to control the transceiver to receive downlink control information (DCI) informing of activation of the dormant BWP from the base station. Since a more specific example of this example is the same as described above, in order to avoid unnecessary repetition of the description, the repetition description of the overlapping content will be omitted.

The monitoring stop unit 1750 may be configured to stop monitoring a physical downlink control channel (PDCCH) on the dormant BWP. Here, based on the activation of the dormant BWP, the BWP inactivity timer, which is a timer for transition to the default BWP, may not be used. Since a more specific example of this example is the same as described above, in order to avoid unnecessary repetition of the description, the repetition description of the overlapping content will be omitted.

Meanwhile, although not shown separately, the embodiments of the present disclosure also provide the following embodiments.

According to an embodiment, provided is an apparatus comprising at least one memory; and at least one processor being operatively connected to the at least one memory, wherein the processor is configured to: control the transceiver to transmit a random access (RA) preamble to a base station; control the transceiver to receive a random access response (RAR) from the base station; control the transceiver to receive, from a base station, dormant bandwidth part (BWP) configuration information, wherein the dormant BWP configuration information is information on a downlink BWP used as a dormant BWP among at least one downlink BWP configured for the UE; control the transceiver to receive, from the base station, downlink control information (DCI) informing an activation of the dormant BWP; and stop physical downlink control channel (PDCCH) monitoring on the dormant BWP, wherein a BWP inactivity timer is not used based on the activation of the dormant BWP, where the BWP inactivity timer is a timer for a transition to a default BWP.

According to another embodiment, provided is at least one computer readable medium comprising instructions being executed by at least one processor, the at least one processor is configured to: control the transceiver to transmit a random access (RA) preamble to a base station; control the transceiver to receive a random access response (RAR) from the base station; control the transceiver to receive, from a base station, dormant bandwidth part (BWP) configuration information, wherein the dormant BWP configuration information is information on a downlink BWP used as a dormant BWP among at least one downlink BWP configured for the UE; control the transceiver to receive, from the base station, downlink control information (DCI) informing an activation of the dormant BWP; and stop physical downlink control channel (PDCCH) monitoring on the dormant BWP, wherein a BWP inactivity timer is not used based on the activation of the dormant BWP, where the BWP inactivity timer is a timer for a transition to a default BWP.

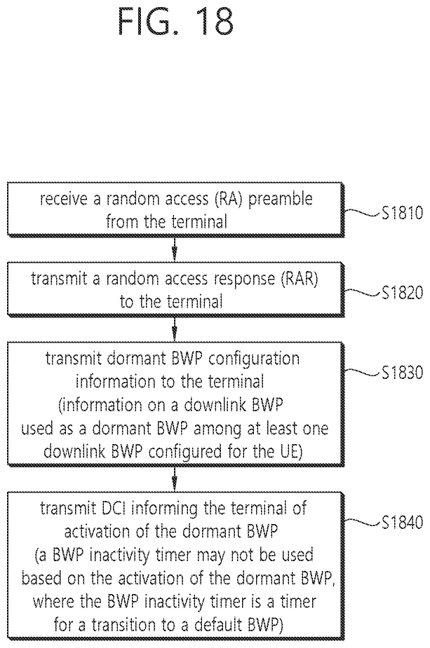

FIG. 18 is a flowchart of an initial access method from a base station perspective, according to an embodiment of the present disclosure.

The base station may receive a random access (RA) preamble from the terminal (S1810). Since a more specific example of this example is the same as described above, in order to avoid unnecessary repetition of the description, the repetition description of the overlapping content will be omitted.

The base station may transmit a random access response (RAR) to the terminal (S1820). Since a more specific example of this example is the same as described above, in order to avoid unnecessary repetition of the description, the repetition description of the overlapping content will be omitted.

The base station may transmit dormant bandwidth part (BWP) configuration information to the terminal (S1830). Here, the dormant BWP configuration information may be information on a downlink BWP used as a dormant BWP among at least one downlink BWP configured for the terminal. Since a more specific example of this example is the same as described above, in order to avoid unnecessary repetition of the description, the repetition description of the overlapping content will be omitted.

The base station may transmit downlink control information (DCI) informing the terminal of activation of the dormant BWP (S1840). Here, based on the activation of the dormant BWP, the BWP inactivity timer, which is a timer for transition to the default BWP, may not be used. Since a more specific example of this example is the same as described above, in order to avoid unnecessary repetition of the description, the repetition description of the overlapping content will be omitted.

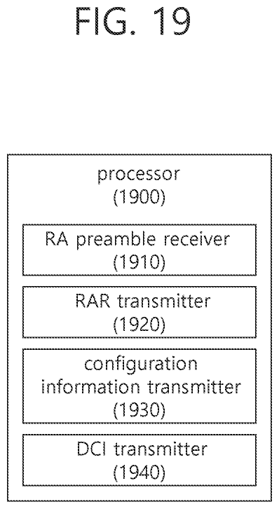

FIG. 19 is a block diagram of an example of an initial access device from the viewpoint of a base station, according to an embodiment of the present disclosure.

Referring to FIG. 19, a processor 1900 may include an RA preamble receiver 1910, an RAR transmitter 1920, a configuration information transmitter 1930, and a DCI transmitter 1940. Here, the processor 1900 may correspond to a processor to be described later or described above.

The RA preamble receiver 1910 may be configured to control the transceiver to receive a random access (RA) preamble from the terminal. Since a more specific example of this example is the same as described above, in order to avoid unnecessary repetition of the description, the repetition description of the overlapping content will be omitted.

The RAR transmitter 1920 may be configured to control the transceiver to transmit a random access response (RAR) to the terminal. Since a more specific example of this example is the same as described above, in order to avoid unnecessary repetition of the description, the repetition description of the overlapping content will be omitted.

The configuration information transmitter 1930 may be configured to control the transceiver to transmit dormant bandwidth part (BWP) configuration information to the terminal. Here, the dormant BWP configuration information may be information on a downlink BWP used as a dormant BWP among at least one downlink BWP configured for the terminal. Since a more specific example of this example is the same as described above, in order to avoid unnecessary repetition of the description, the repetition description of the overlapping content will be omitted.

The DCI transmitter 1940 may be configured to control the transceiver to transmit downlink control information (DCI) informing the terminal of activation of the dormant BWP. Here, based on the activation of the dormant BWP, the BWP inactivity timer, which is a timer for transition to the default BWP, may not be used. Since a more specific example of this example is the same as described above, in order to avoid unnecessary repetition of the description, the repetition description of the overlapping content will be omitted.

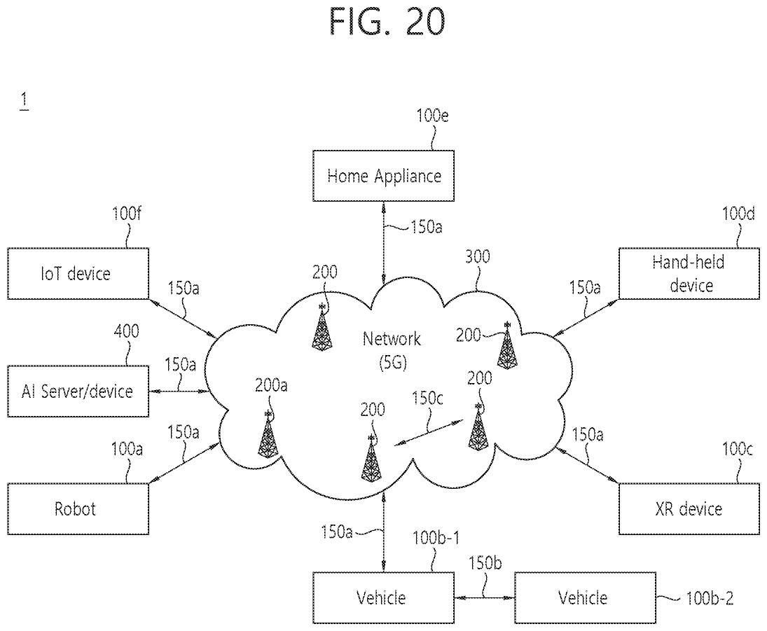

FIG. 20 illustrates a communication system 1 applied to the disclosure.

Referring to FIG. 20, the communication system 1 applied to the disclosure includes a wireless device, a base station, and a network. Here, the wireless device refers to a device that performs communication using a radio access technology (e.g., 5G new RAT (NR) or Long-Term Evolution (LTE)) and may be referred to as a communication/wireless/5G device. The wireless device may include, but limited to, a robot 100a, a vehicle 100b-1 and 100b-2, an extended reality (XR) device 100c, a hand-held device 100d, a home appliance 100e, an Internet of things (IoT) device 100f, and an AI device/server 400. For example, the vehicle may include a vehicle having a wireless communication function, an autonomous driving vehicle, a vehicle capable of inter-vehicle communication, or the like. Here, the vehicle may include an unmanned aerial vehicle (UAV) (e.g., a drone). The XR device may include augmented reality (AR)/virtual reality (VR)/mixed reality (MR) devices and may be configured as a head-mounted device (HMD), a vehicular head-up display (HUD), a television, a smartphone, a computer, a wearable device, a home appliance, digital signage, a vehicle, a robot, or the like. The hand-held device may include a smartphone, a smartpad, a wearable device (e.g., a smart watch or smart glasses), and a computer (e.g., a notebook). The home appliance may include a TV, a refrigerator, a washing machine, and the like. The IoT device may include a sensor, a smart meter, and the like. The base station and the network may be configured, for example, as wireless devices, and a specific wireless device 200a may operate as a base station/network node for other wireless devices.

Here, the wireless communication technology implemented in the wireless device of the present disclosure may include a narrowband Internet of Things for low-power communication as well as LTE, NR, and 6G. At this time, for example, NB-IoT technology may be an example of low power wide area network (LPWAN) technology, and may be implemented in standards such as LTE Cat NB1 and/or LTE Cat NB2, may be implemented in the standard of LTE Cat NB1 and/or LTE Cat NB2, and is not limited to the names mentioned above. Additionally or alternatively, the wireless communication technology implemented in the wireless device of the present disclosure may perform communication based on LTE-M technology. In this case, as an example, the LTE-M technology may be an example of an LPWAN technology, and may be called by various names such as enhanced machine type communication (eMTC). For example, LTE-M technology may be implemented by at least any one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the names described above. Additionally or alternatively, the wireless communication technology implemented in the wireless device of the present disclosure may include at least one of ZigBee, Bluetooth, and LPWAN considering low power communication and is not limited to the names described above. For example, the ZigBee technology may create personal area networks (PAN) related to small/low-power digital communication based on various standards such as IEEE 802.15.4, and may be called by various names.

The wireless devices 100a to 100f may be connected to the network 300 through the base station 200. Artificial intelligence (AI) technology may be applied to the wireless devices 100a to 100f, and the wireless devices 100a to 100f may be connected to an AI server 400 through the network 300. The network 300 may be configured using a 3G network, a 4G (e.g., LTE) network, or a 5G (e.g., NR) network. The wireless devices 100a to 100f may communicate with each other via the base station 200/network 300 and may also perform direct communication (e.g. sidelink communication) with each other without passing through the base station/network. For example, the vehicles 100b-1 and 100b-2 may perform direct communication (e.g. vehicle-to-vehicle (V2V)/vehicle-to-everything (V2X) communication). Further, the IoT device (e.g., a sensor) may directly communicate with another IoT device (e.g., a sensor) or another wireless device 100a to 100f.

Wireless communications/connections 150a, 150b, and 150c may be established between the wireless devices 100a to 100f and the base station 200 and between the base stations 200. Here, the wireless communications/connections may be established by various wireless access technologies (e.g., 5G NR), such as uplink/downlink communication 150a, sidelink communication 150b (or D2D communication), and inter-base station communication 150c (e.g., relay or integrated access backhaul (IAB)). The wireless devices and the base station/wireless devices, and the base stations may transmit/receive radio signals to/from each other through the wireless communications/connections 150a, 150b, and 150c. For example, the wireless communications/connections 150a, 150b, and 150c may transmit/receive signals over various physical channels. To this end, at least some of various configuration information setting processes, various signal processing processes (e.g., channel encoding/decoding, modulation/demodulation, resource mapping/demapping, and the like), and resource allocation processes may be performed on the basis of various proposals of the disclosure.

Meanwhile, NR supports a plurality of numerologies (or a plurality of ranges of subcarrier spacing (SCS)) in order to support a variety of 5G services. For example, when SCS is 15 kHz, a wide area in traditional cellular bands is supported; when SCS is 30 kHz/60 kHz, a dense-urban, lower-latency, and wider-carrier bandwidth is supported; when SCS is 60 kHz or higher, a bandwidth greater than 24.25 GHz is supported to overcome phase noise.

NR frequency bands may be defined as frequency ranges of two types (FR1 and FR2). The values of the frequency ranges may be changed. For example, the frequency ranges of the two types (FR1 and FR2) may be as shown in Table 11. For convenience of description, FR1 of the frequency ranges used for an NR system may refer to a “sub 6 GHz range”, and FR2 may refer to an “above 6 GHz range” and may be referred to as a millimeter wave (mmW).

TABLE 11

| Frequency range | Corresponding | Subcarrier |
|---|---|---|
| designation | frequency range | spacing |
| FR1 | 450 MHz-6000 MHz | 15, 30, 60 kHz |
| FR2 | 24250 MHz-52600 MHz | 60, 120, 240 kHz |

As illustrated above, the values of the frequency ranges for the NR system may be changed. For example, FR1 may include a band from 410 MHz to 7125 MHz as shown in Table 12. That is, FR1 may include a frequency band of 6 GHz (or 5850, 5900, 5925 MHz, or the like) or greater. For example, the frequency band of 6 GHz (or 5850, 5900, 5925 MHz, or the like) or greater included in FR1 may include an unlicensed band. The unlicensed bands may be used for a variety of purposes, for example, for vehicular communication (e.g., autonomous driving).

TABLE 12

| Frequency range | Corresponding | |
|---|---|---|
| designation | frequency range | Subcarrier spacing |
| FR1 | 410 MHz-7125 MHz | 15, 30, 60 kHz |
| FR2 | 24250 MHz-52600 MHz | 60, 120, 240 kHz |

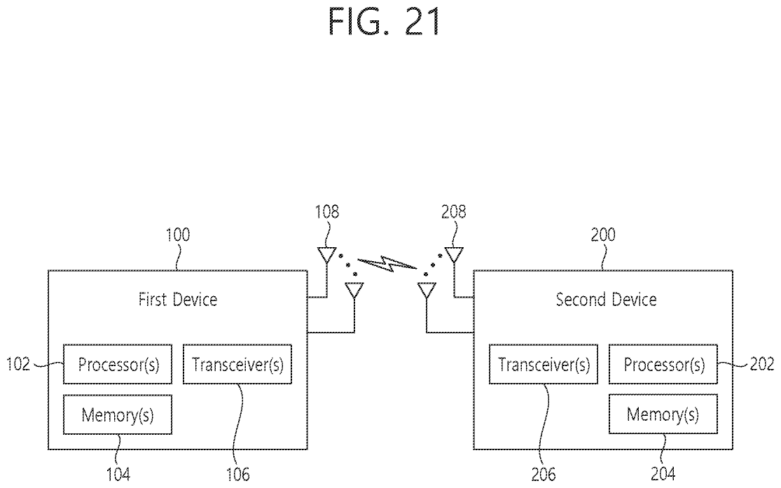

Hereinafter, an example of a wireless device to which the disclosure is applied is described. FIG. 21 illustrates a wireless device that is applicable to the disclosure.

Referring to FIG. 21, a first wireless device 100 and a second wireless device 200 may transmit and receive radio signals through various radio access technologies (e.g., LTE and NR). Here, the first wireless device 100 and the second wireless device 200 may respectively correspond to a wireless device 100x and the base station 200 of FIG. 20 and/or may respectively correspond to a wireless device 100x and a wireless device 100x of FIG. 20.

The first wireless device 100 includes at least one processor 102 and at least one memory 104 and may further include at least one transceiver 106 and/or at least one antenna 108. The processor 102 may be configured to control the memory 104 and/or the transceiver 106 and to implement the descriptions, functions, procedures, proposals, methods, and/or operational flowcharts disclosed herein. For example, the processor 102 may process information in the memory 104 to generate first information/signal and may then transmit a radio signal including the first information/signal through the transceiver 106. In addition, the processor 102 may receive a radio signal including second information/signal through the transceiver 106 and may store information obtained from signal processing of the second information/signal in the memory 104. The memory 104 may be connected to the processor 102 and may store various pieces of information related to the operation of the processor 102. For example, the memory 104 may store a software code including instructions to perform some or all of processes controlled by the processor 102 or to perform the descriptions, functions, procedures, proposals, methods, and/or operational flowcharts disclosed herein. Here, the processor 102 and the memory 104 may be part of a communication modem/circuit/chip designed to implement a radio communication technology (e.g., LTE or NR). The transceiver 106 may be connected with the processor 102 and may transmit and/or receive a radio signal via the at least one antennas 108. The transceiver 106 may include a transmitter and/or a receiver. The transceiver 106 may be replaced with a radio frequency (RF) unit. In the disclosure, the wireless device may refer to a communication modem/circuit/chip.

The second wireless device 200 includes at least one processor 202 and at least one memory 204 and may further include at least one transceiver 206 and/or at least one antenna 208. The processor 202 may be configured to control the memory 204 and/or the transceiver 206 and to implement the descriptions, functions, procedures, proposals, methods, and/or operational flowcharts disclosed herein. For example, the processor 202 may process information in the memory 204 to generate third information/signal and may then transmit a radio signal including the third information/signal through the transceiver 206. In addition, the processor 202 may receive a radio signal including fourth information/signal through the transceiver 206 and may store information obtained from signal processing of the fourth information/signal in the memory 204. The memory 204 may be connected to the processor 202 and may store various pieces of information related to the operation of the processor 202. For example, the memory 204 may store a software code including instructions to perform some or all of processes controlled by the processor 202 or to perform the descriptions, functions, procedures, proposals, methods, and/or operational flowcharts disclosed herein. Here, the processor 202 and the memory 204 may be part of a communication modem/circuit/chip designed to implement a radio communication technology (e.g., LTE or NR). The transceiver 206 may be connected with the processor 202 and may transmit and/or receive a radio signal via the at least one antennas 208. The transceiver 206 may include a transmitter and/or a receiver. The transceiver 206 may be replaced with an RF unit. In the disclosure, the wireless device may refer to a communication modem/circuit/chip.

Hereinafter, hardware elements of the wireless devices 100 and 200 are described in detail. At least one protocol layer may be implemented, but limited to, by the at least one processor 102 and 202. For example, the at least one processor 102 and 202 may implement at least one layer (e.g., a functional layer, such as PHY, MAC, RLC, PDCP, RRC, and SDAP layers). The at least one processor 102 and 202 may generate at least one protocol data unit (PDU) and/or at least one service data unit (SDU) according to the descriptions, functions, procedures, proposals, methods, and/or operational flowcharts disclosed herein. The at least one processor 102 and 202 may generate a message, control information, data, or information according to the descriptions, functions, procedures, proposals, methods, and/or operational flowcharts disclosed herein. The at least one processor 102 and 202 may generate a signal (e.g., a baseband signal) including a PDU, an SDU, a message, control information, data, or information according to the functions, procedures, proposals, and/or methods disclosed herein and may provide the signal to the at least one transceiver 106 and 206. The at least one processor 102 and 202 may receive a signal (e.g., a baseband signal) from the at least one transceiver 106 and 206 and may obtain a PDU, an SDU, a message, control information, data, or information according to the descriptions, functions, procedures, proposals, methods, and/or operational flowcharts disclosed herein.

The at least one processor 102 and 202 may be referred to as a controller, a microcontroller, a microprocessor, or a microcomputer. The at least one processor 102 and 202 may be implemented by hardware, firmware, software, or a combination thereof. For example, at least one application-specific integrated circuit (ASIC), at least one digital signal processor (DSP), at least one digital signal processing devices (DSPD), at least one programmable logic devices (PLD), or at least one field programmable gate array (FPGA) may be included in the at least one processor 102 and 202. The descriptions, functions, procedures, proposals, methods, and/or operational flowcharts disclosed herein may be implemented using firmware or software, and the firmware or software may be configured to include modules, procedures, functions, and the like. The firmware or software configured to perform the descriptions, functions, procedures, proposals, methods, and/or operational flowcharts disclosed herein may be included in the at least one processor 102 and 202 or may be stored in the at least one memory 104 and 204 and may be executed by the at least one processor 102 and 202. The descriptions, functions, procedures, proposals, methods, and/or operational flowcharts disclosed herein may be implemented in the form of a code, an instruction, and/or a set of instructions using firmware or software.

The at least one memory 104 and 204 may be connected to the at least one processor 102 and 202 and may store various forms of data, signals, messages, information, programs, codes, indications, and/or commands. The at least one memory 104 and 204 may be configured as a ROM, a RAM, an EPROM, a flash memory, a hard drive, a register, a cache memory, a computer-readable storage medium, and/or a combinations thereof. The at least one memory 104 and 204 may be disposed inside and/or outside the at least one processor 102 and 202. In addition, the at least one memory 104 and 204 may be connected to the at least one processor 102 and 202 through various techniques, such as a wired or wireless connection.

The at least one transceiver 106 and 206 may transmit user data, control information, a radio signal/channel, or the like mentioned in the methods and/or operational flowcharts disclosed herein to at least different device. The at least one transceiver 106 and 206 may receive user data, control information, a radio signal/channel, or the like mentioned in the descriptions, functions, procedures, proposals, methods, and/or operational flowcharts disclosed herein from at least one different device. For example, the at least one transceiver 106 and 206 may be connected to the at least one processor 102 and 202 and may transmit and receive a radio signal. For example, the at least one processor 102 and 202 may control the at least one transceiver 106 and 206 to transmit user data, control information, or a radio signal to at least one different device. In addition, the at least one processor 102 and 202 may control the at least one transceiver 106 and 206 to receive user data, control information, or a radio signal from at least one different device. The at least one transceiver 106 and 206 may be connected to the at least one antenna 108 and 208 and may be configured to transmit or receive user data, control information, a radio signal/channel, or the like mentioned in the descriptions, functions, procedures, proposals, methods, and/or operational flowcharts disclosed herein through the at least one antenna 108 and 208. In this document, the at least one antenna may be a plurality of physical antennas or may be a plurality of logical antennas (e.g., antenna ports). The at least one transceiver 106 and 206 may convert a received radio signal/channel from an RF band signal into a baseband signal in order to process received user data, control information, a radio signal/channel, or the like using the at least one processor 102 and 202. The at least one transceiver 106 and 206 may convert user data, control information, a radio signal/channel, or the like, processed using the at least one processor 102 and 202, from a baseband signal to an RF bad signal. To this end, the at least one transceiver 106 and 206 may include an (analog) oscillator and/or a filter.

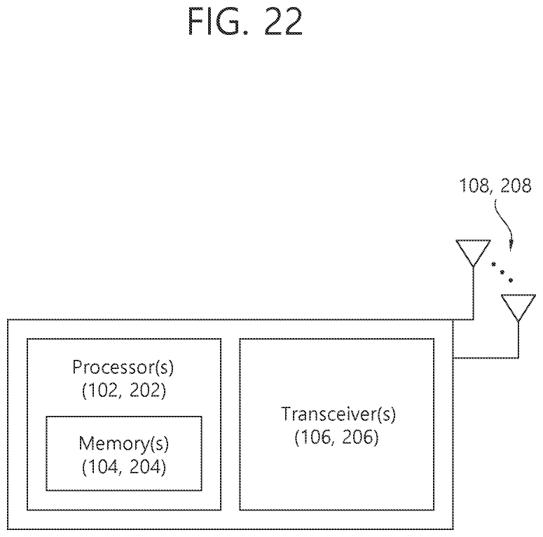

FIG. 22 illustrates another example of a wireless device applicable to the present disclosure.

Referring to FIG. 22, a wireless device may include at least one processor 102, 202, at least one memory 104, 204, at least one transceiver 106, 206, and one or more antennas 108, 208.

As a difference between the example of the wireless device described above in FIG. 21 and the example of the wireless device in FIG. 22, the processors 102 and 202 and the memories 104 and 204 are separated in FIG. 21, and the processors 102 and 202 include the memories 104 and 204 in FIG. 22.

Here, the specific description of the processor 102, 202, the memory 104, 204, the transceiver 106, 206, and one or more antennas 108, 208 is same as described above, repeated descriptions will be omitted in order to avoid unnecessary repetition of descriptions.

Hereinafter, an example of a signal processing circuit to which the disclosure is applied is described.

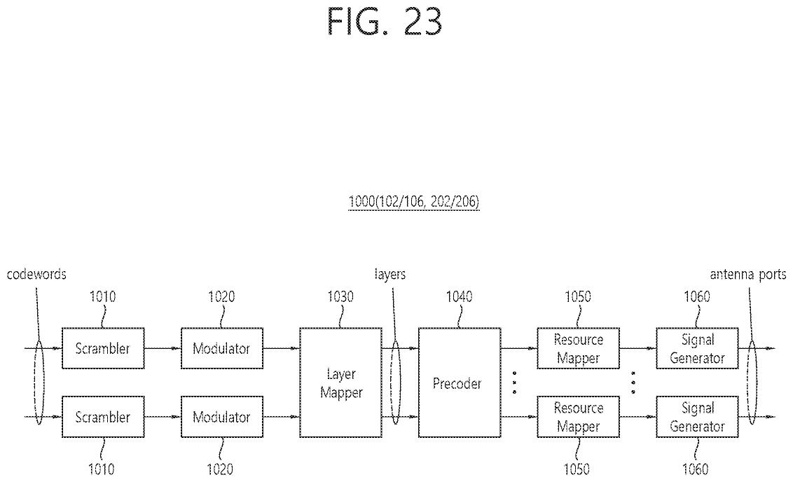

FIG. 23 illustrates a signal processing circuit for a transmission signal.

Referring to FIG. 23, the signal processing circuit 1000 may include a scrambler 1010, a modulator 1020, a layer mapper 1030, a precoder 1040, a resource mapper 1050, and a signal generator 1060. Operations/functions illustrated with reference to FIG. 23 may be performed, but not limited to, in the processor 102 and 202 and/or the transceiver 106 and 206 of FIG. 21. Hardware elements illustrated in FIG. 23 may be configured in the processor 102 and 202 and/or the transceiver 106 and 206 of FIG. 21. For example, blocks 1010 to 1060 may be configured in the processor 102 and 202 of FIG. 21. Alternatively, blocks 1010 to 1050 may be configured in the processor 102 and 202 of FIG. 21, and a block 1060 may be configured in the transceiver 106 and 206 of FIG. 21.

A codeword may be converted into a radio signal via the signal processing circuit 1000 of FIG. 23. Here, the codeword is an encoded bit sequence of an information block. The information block may include a transport block (e.g., a UL-SCH transport block and a DL-SCH transport block). The radio signal may be transmitted through various physical channels (e.g., a PUSCH or a PDSCH).

Specifically, the codeword may be converted into a scrambled bit sequence by the scrambler 1010. A scrambled sequence used for scrambling is generated on the basis of an initialization value, and the initialization value may include ID information about a wireless device. The scrambled bit sequence may be modulated into a modulation symbol sequence by the modulator 1020. A modulation scheme may include pi/2-binary phase shift keying (pi/2-BPSK), m-phase shift keying (m-PSK), m-quadrature amplitude modulation (m-QAM), and the like. A complex modulation symbol sequence may be mapped to at least one transport layer by the layer mapper 1030. Modulation symbols of each transport layer may be mapped to a corresponding antenna port(s) by the precoder 1040 (precoding). Output z from the precoder 1040 may be obtained by multiplying output y from the layer mapper 1030 by a precoding matrix W of N*M, where N is the number of antenna ports, and M is the number of transport layers. Here, the precoder 1040 may perform precoding after performing transform precoding (e.g., DFT transform) on complex modulation symbols. Alternatively, the precoder 1040 may perform precoding without performing transform precoding.

The resource mapper 1050 may map a modulation symbol of each antenna port to a time-frequency resource. The time-frequency resource may include a plurality of symbols (e.g., CP-OFDMA symbols or DFT-s-OFDMA symbols) in the time domain and may include a plurality of subcarriers in the frequency domain. The signal generator 1060 may generate a radio signal from mapped modulation symbols, and the generated radio signal may be transmitted to another device through each antenna. To this end, the signal generator 1060 may include an inverse fast Fourier transform (IFFT) module, a cyclic prefix (CP) inserter, a digital-to-analog converter (DAC), a frequency upconverter, and the like.

A signal processing procedure for a received signal in a wireless device may be performed in the reverse order of the signal processing procedure 1010 to 1060 of FIG. 23. For example, a wireless device (e.g., 100 and 200 of FIG. 21) may receive a radio signal from the outside through an antenna port/transceiver. The received radio signal may be converted into a baseband signal through a signal reconstructor. To this end, the signal reconstructor may include a frequency downconverter, an analog-to-digital converter (ADC), a CP remover, and a fast Fourier transform (FFT) module. The baseband signal may be reconstructed to a codeword through resource demapping, postcoding, demodulation, and descrambling. The codeword may be reconstructed to an original information block through decoding. Thus, a signal processing circuit (not shown) for a received signal may include a signal reconstructor, a resource demapper, a postcoder, a demodulator, a descrambler and a decoder.

Hereinafter, an example of utilizing a wireless device to which the disclosure is applied is described.

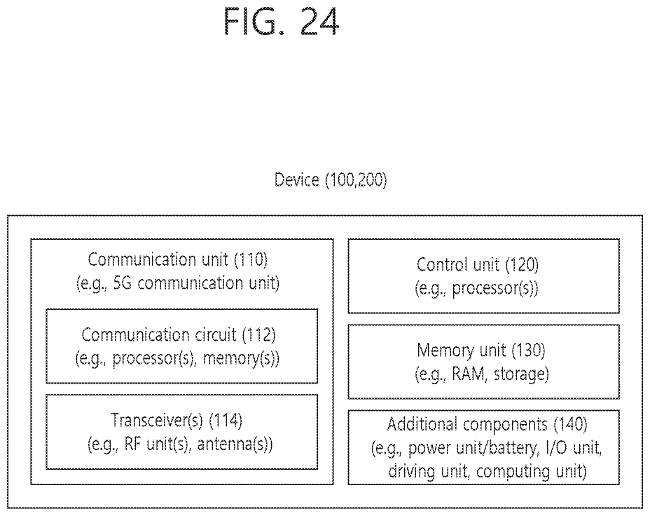

FIG. 24 illustrates another example of a wireless device applied to the disclosure. The wireless device may be configured in various forms depending on usage/service.

Referring to FIG. 24, the wireless devices 100 and 200 may correspond to the wireless device 100 and 200 of FIG. 21 and may include various elements, components, units, and/or modules. For example, the wireless device 100 and 200 may include a communication unit 110, a control unit 120, a memory unit 130, and additional components 140. The communication unit may include a communication circuit 112 and a transceiver(s) 114. For example, the communication circuit 112 may include the at least one processor 102 and 202 and/or the at least one memory 104 and 204 of FIG. 21. For example, the transceiver(s) 114 may include the at least one transceiver 106 and 206 and/or the at least one antenna 108 and 208 of FIG. 21. The control unit 120 is electrically connected to the communication unit 110, the memory unit 130, and the additional components 140 and controls overall operations of the wireless device. For example, the control unit 120 may control electrical/mechanical operations of the wireless device on the basis of a program/code/command/information stored in the memory unit 130. In addition, the control unit 120 may transmit information stored in the memory unit 130 to the outside (e.g., a different communication device) through a wireless/wired interface via the communication unit 110 or may store, in the memory unit 130, information received from the outside (e.g., a different communication device) through the wireless/wired interface via the communication unit 110.

The additional components 140 may be configured variously depending on the type of the wireless device. For example, the additional components 140 may include at least one of a power unit/battery, an input/output (I/O) unit, a driving unit, and a computing unit. The wireless device may be configured, but not limited to, as a robot (100a in FIG. 20), a vehicle (100b-1 or 100b-2 in FIG. 20), an XR device (100c in FIG. 20), a hand-held device (100d in FIG. 20), a home appliance (100e in FIG. 20), an IoT device (100f in FIG. 20), a terminal for digital broadcasting, a hologram device, a public safety device, an MTC device, a medical device, a fintech device (or financial device), a security device, a climate/environmental device, an AI server/device (400 in FIG. 20), a base station (200 in FIG. 20), a network node, or the like. The wireless device may be mobile or may be used in a fixed place depending on usage/service.

In FIG. 24, all of the various elements, components, units, and/or modules in the wireless devices 100 and 200 may be connected to each other through a wired interface, or at least some thereof may be wirelessly connected through the communication unit 110. For example, the control unit 120 and the communication unit 110 may be connected via a cable in the wireless device 100 and 200, and the control unit 120 and a first unit (e.g., 130 and 140) may be wirelessly connected through the communication unit 110. In addition, each element, component, unit, and/or module in wireless device 100 and 200 may further include at least one element. For example, the control unit 120 may include at least one processor set. For example, the control unit 120 may be configured as a set of a communication control processor, an application processor, an electronic control unit (ECU), a graphics processing processor, a memory control processor, and the like. In another example, the memory unit 130 may include a random-access memory (RAM), a dynamic RAM (DRAM), a read-only memory (ROM), a flash memory, a volatile memory, a non-volatile memory, and/or a combination thereof

Next, an illustrative configuration of FIG. 24 is described in detail with reference to the accompanying drawing.

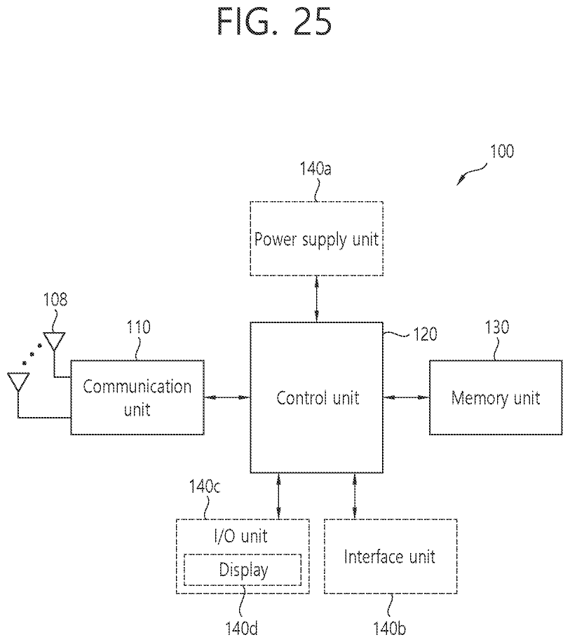

FIG. 25 illustrates a hand-held device applied to the disclosure. The hand-held device may include a smartphone, a smartpad, a wearable device (e.g., a smart watch or smart glasses), and a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 25, the hand-held device 100 may include an antenna unit 108, a communication unit 110, a control unit 120, a memory unit 130, a power supply unit 140a, an interface unit 140b, and an input/output unit 140c. The antenna unit 108 may be configured as a part of the communication unit 110. Blocks 110 to 130/140a to 140c correspond to the blocks 110 to 130/140 in FIG. 24, respectively.

The communication unit 110 may transmit and receive a signal (e.g., data, a control signal, or the like) to and from other wireless devices and base stations. The control unit 120 may control various components of the hand-held device 100 to perform various operations. The control unit 120 may include an application processor (AP). The memory unit 130 may store data/parameter/program/code/command necessary to drive the hand-held device 100. Further, the memory unit 130 may store input/output data/information. The power supply unit 140a supplies power to the hand-held device 100 and may include a wired/wireless charging circuit, a battery, and the like. The interface unit 140b may support a connection between the hand-held device 100 and a different external device. The interface unit 140b may include various ports (e.g., an audio input/output port and a video input/output port) for connection to an external device. The input/output unit 140c may receive or output image information/signal, audio information/signal, data, and/or information input from a user. The input/output unit 140c may include a camera, a microphone, a user input unit, a display unit 140d, a speaker, and/or a haptic module.

For example, in data communication, the input/output unit 140c may obtain information/signal (e.g., a touch, text, voice, an image, and a video) input from the user, and the obtained information/signal may be stored in the memory unit 130. The communication unit 110 may convert information/signal stored in the memory unit into a radio signal and may transmit the converted radio signal directly to a different wireless device or to a base station. In addition, the communication unit 110 may receive a radio signal from a different wireless device or the base station and may reconstruct the received radio signal to original information/signal. The reconstructed information/signal may be stored in the memory unit 130 and may then be output in various forms (e.g., text, voice, an image, a video, and a haptic form) through the input/output unit 140c.

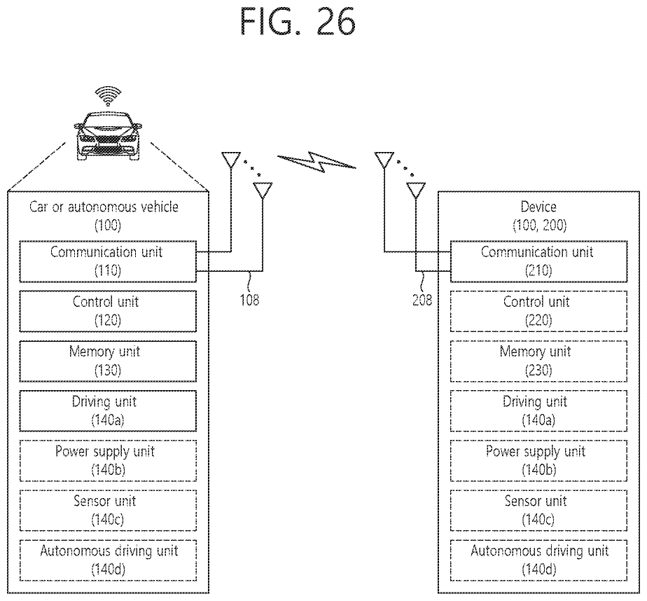

FIG. 26 illustrates a vehicle or an autonomous driving vehicle applied to the disclosure. The vehicle or the autonomous driving may be configured as a mobile robot, a car, a train, a manned/unmanned aerial vehicle (AV), a ship, or the like.

Referring to FIG. 26, the vehicle or the autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. Blocks 110/130/140a to 140d correspond to the blocks 110/130/140 in FIG. 24, respectively.

The communication unit 110 may transmit and receive a signal (e.g., data, a control signal, or the like) to and from external devices, such as a different vehicle, a base station (e.g. a base station, a road-side unit, or the like), and a server. The control unit 120 may control elements of the vehicle or the autonomous driving vehicle 100 to perform various operations. The control unit 120 may include an electronic control unit (ECU). The driving unit 140a may enable the vehicle or the autonomous driving vehicle 100 to run on the ground. The driving unit 140a may include an engine, a motor, a power train, wheels, a brake, a steering device, and the like. The power supply unit 140b supplies power to the vehicle or the autonomous driving vehicle 100 and may include a wired/wireless charging circuit, a battery, and the like. The sensor unit 140c may obtain a vehicle condition, environmental information, user information, and the like. The sensor unit 140c may include an inertial measurement unit (IMU) sensor, a collision sensor, a wheel sensor, a speed sensor, an inclination sensor, a weight sensor, a heading sensor, a position module, vehicular forward/backward vision sensors, a battery sensor, a fuel sensor, a tire sensor, a steering sensor, a temperature sensor, a humidity sensor, an ultrasonic sensor, an illuminance sensor, a pedal position sensor, and the like. The autonomous driving unit 140d may implement a technology for maintaining a driving lane, a technology for automatically adjusting speed, such as adaptive cruise control, a technology for automatic driving along a set route, a technology for automatically setting a route and driving when a destination is set, and the like.

For example, the communication unit 110 may receive map data, traffic condition data, and the like from an external server. The autonomous driving unit 140d may generate an autonomous driving route and a driving plan on the basis of obtained data. The control unit 120 may control the driving unit 140a to move the vehicle or the autonomous driving vehicle 100 along the autonomous driving route according to the driving plan (e.g., speed/direction control). During autonomous driving, the communication unit 110 may aperiodically/periodically obtain updated traffic condition data from the external server and may obtain surrounding traffic condition data from a neighboring vehicle. Further, during autonomous driving, the sensor unit 140c may obtain a vehicle condition and environmental information. The autonomous driving unit 140d may update the autonomous driving route and the driving plan on the basis of newly obtained data/information. The communication unit 110 may transmit information about a vehicle location, an autonomous driving route, a driving plan, and the like to the external server. The external server may predict traffic condition data in advance using AI technology or the like on the basis of information collected from vehicles or autonomous driving vehicles and may provide the predicted traffic condition data to the vehicles or the autonomous driving vehicles.

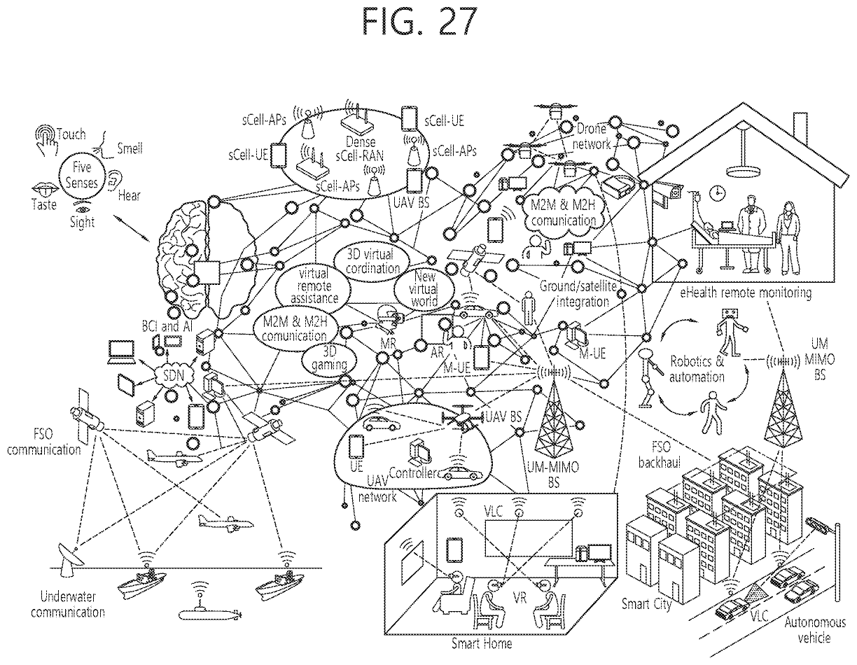

FIG. 27 is a diagram illustrating an example of a communication structure that can be provided in a 6G system.

6G systems are expected to have 50 times higher simultaneous wireless connectivity than 5G wireless communication systems. URLLC, a key feature of 5G, will become an even more important technology by providing an end-to-end delay of less than 1 ms in 6G communication. 6G systems will have much better volumetric spectral efficiencies as opposed to frequently used areal spectral efficiencies. The 6G system can provide very long battery life and advanced battery technology for energy harvesting, so mobile devices will not need to be charged separately in the 6G system. New network characteristics in 6G may be as follows.
Satellites integrated network: 6G is expected to be integrated with satellites to provide a global mobile population. The integration of terrestrial, satellite and public networks into one wireless communication system is very important for 6G.
Connected intelligence: Unlike previous generations of wireless communication systems, 6G is revolutionary and will update the evolution of wireless from “connected things” to “connected intelligence”. AI may be applied in each step of a communication procedure (or each procedure of signal processing to be described later).
Seamless integration wireless information and energy transfer: The 6G wireless network will deliver power to charge the batteries of devices such as smartphones and sensors. Therefore, wireless information and energy transfer (WIET) will be integrated.
Ubiquitous super 3D connectivity: access to networks and core network functions of drones and very low Earth orbit satellites will create super 3D connectivity in 6G ubiquitous.

In the above new network characteristics of 6G, some general requirements may be as follows.
Small cell networks: The idea of small cell networks was introduced to improve the received signal quality as a result of improved throughput, energy efficiency and spectral efficiency in cellular systems. As a result, small cell networks are essential characteristics for communication systems beyond 5G and Beyond 5G (5GB). Accordingly, the 6G communication system also adopts the characteristics of the small cell network.
Ultra-dense heterogeneous network: Ultra-dense heterogeneous networks will be another important characteristic of 6G communication systems. A multi-tier network composed of heterogeneous networks improves overall QoS and reduces costs.
High-capacity backhaul: A backhaul connection is characterized as a high-capacity backhaul network to support high-capacity traffic. High-speed fiber optics and free-space optics (FSO) systems may be possible solutions to this problem.
Radar technology integrated with mobile technology: High-precision localization (or location-based service) through communication is one of the functions of the 6G wireless communication system. Therefore, the radar system will be integrated with the 6G network.
Softwarization and virtualization: Softening and virtualization are two important features that underlie the design process in 5GB networks to ensure flexibility, reconfigurability and programmability. In addition, billions of devices can be shared in a shared physical infrastructure.

The appended claims of the present disclosure may be combined in various ways. For example, technical features of method claims of the present disclosure may be combined to be implemented as an apparatus, and technical features of apparatus claims of the present disclosure may be combined to be implemented as a method. Also, technical features of method claims and technical features of apparatus claims of the present disclosure may be combined to be implemented as an apparatus, and technical features of method claims and technical features of apparatus claims of the present disclosure may be combined to be implemented as a method.

1. A method performed by a user equipment (UE) in a wireless communication system, the method comprising:
receiving, from a base station, dormant bandwidth part (BWP) configuration information, wherein the dormant BWP configuration information is information regarding a downlink BWP used as a dormant BWP among at least one downlink BWP configured for the UE;
receiving, from the base station, downlink control information (DCI) informing an activation of the dormant BWP; and
stopping physical downlink control channel (PDCCH) monitoring on the dormant BWP,
wherein a maximum number of the at least one downlink BWP is 4,
wherein a BWP inactivity timer is not used based on the activation of the dormant BWP, where the BWP inactivity timer is a timer for a transition to a default BWP.

2. The method of claim 1, wherein the dormant BWP is a BWP which is different from the default BWP.

3. The method of claim 2, wherein based on the dormant BWP being different from the default BWP, the BWP inactivity timer is not used.

4. The method of claim 1, wherein based on the dormant BWP being activated and the BWP inactivity timer being running, the UE stops the BWP inactivity timer.

5. The method of claim 1, wherein based on the BWP inactivity timer being released, the UE stops the BWP inactivity timer without transitioning to the default BWP.

6. The method of claim 1, wherein the UE transmits ACK/NACK (acknowledgement/negative-acknowledgement) information for the DCI to the base station.

7. The method of claim 6, wherein based on the DCI including information for scheduling a physical downlink shared channel (PDSCH), the ACK/NACK information is ACK/NACK information about the PDSCH.

8. The method of claim 6, wherein the DCI informs a specific resource on which the ACK/NACK information is transmitted.

9. The method of claim 1, wherein the UE continues to perform channel state information (CSI) measurement on the dormant BWP.

10. The method of claim 1, wherein the default BWP is a BWP that the UE transitions based on the BWP inactivity timer expiring.

11. A user equipment (UE) comprising:
a transceiver;
at least one memory; and
at least one processor being operatively connected to the at least one memory and the transceiver,
wherein the processor is configured to:
control the transceiver to receive, from a base station, dormant bandwidth part (BWP) configuration information, wherein the dormant BWP configuration information is information regarding a downlink BWP used as a dormant BWP among at least one downlink BWP configured for the UE;
control the transceiver to receive, from the base station, downlink control information (DCI) informing an activation of the dormant BWP; and
stop physical downlink control channel (PDCCH) monitoring on the dormant BWP,
wherein a maximum number of the at least one downlink BWP is 4,
wherein a BWP inactivity timer is not used based on the activation of the dormant BWP, where the BWP inactivity timer is a timer for a transition to a default BWP.

12. An apparatus comprising:
at least one memory; and
at least one processor being operatively connected to the at least one memory, wherein the processor is configured to:
control the transceiver to receive, from a base station, dormant bandwidth part (BWP) configuration information, wherein the dormant BWP configuration information is information regarding a downlink BWP used as a dormant BWP among at least one downlink BWP configured for the apparatus;
control the transceiver to receive, from the base station, downlink control information (DCI) informing an activation of the dormant BWP; and
stop physical downlink control channel (PDCCH) monitoring on the dormant BWP,
wherein a maximum number of the at least one downlink BWP is 4,
wherein a BWP inactivity timer is not used based on the activation of the dormant BWP, where the BWP inactivity timer is a timer for a transition to a default BWP.

13-15. (canceled)
